(19) United States
(12) Patent Application Publication
(10) Pub. No.: US 2022/0060356 A1
(43) Pub. Date: Feb. 24, 2022

(54) SOUNDING REFERENCE SIGNAL (SRS) CONFIGURATION MODIFICATION

(71) Applicant: QUALCOMM Incorporated, San Diego, CA (US)

(72) Inventors: Mahmoud TAHERZADEH BOROUJENI, San Diego, CA (US); Tao LUO, San Diego, CA (US); Iyab Issam SAKHNINI, San Diego, CA (US); Juan MONTOJO, San Diego, CA (US); Junyi LI, Fairless Hills, PA (US); Peter GAAL, San Diego, CA (US); Xiaoxia ZHANG, San Diego, CA (US); Jelena DAMNJANOVIC, Del Mar, CA (US)

(21) Appl. No.: 17/445,165

(22) Filed: Aug. 16, 2021

Related U.S. Application Data
(60) Provisional application No. 63/068,682, filed on Aug. 21, 2020.
(60) Provisional application No. 63/068,715, filed on Aug. 21, 2020.

(51) Int. Cl. H04L 25/02; H04L 5/00; H04W 72/12; H04W 72/04

(52) U.S. Cl. CPC H04L 25/0226; H04W 72/0446; H04W 72/1263; H04L 5/0051

(57) ABSTRACT

Various aspects of the present disclosure generally relate to wireless communication. In some aspects, a user equipment (UE) may receive a configuration message that includes a sounding reference signal (SRS) configuration that indicates a first set of SRS transmission parameters for the UE. The UE may receive an indication to modify the SRS configuration, wherein the indication is associated with a second set of SRS transmission parameters that is different from the first set of SRS transmission parameters. The UE may transmit one or more SRSs according to the second set of SRS transmission parameters and based at least in part on receiving the indication. Numerous other aspects are provided.

### CROSS-REFERENCE TO RELATED APPLICATION

This patent application claims priority to U.S. Provisional Patent Application No. 63/068,682, filed on Aug. 21, 2020, entitled “SOUNDING REFERENCE SIGNAL (SRS) CONFIGURATION MODIFICATION,” and assigned to the assignee hereof. This patent application also claims priority to U.S. Provisional Patent Application No. 63/068,715, filed on Aug. 21, 2020, entitled “DYNAMIC SWITCHING OF SOUNDING REFERENCE SIGNAL (SRS) CONFIGURATIONS,” and assigned to the assignee hereof. The disclosures of the prior applications are considered part of and are incorporated by reference into this patent application.

### FIELD OF THE DISCLOSURE

Aspects of the present disclosure generally relate to wireless communication and to techniques and apparatuses for sounding reference signal configuration modification.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” refers to the communication link from the BS to the UE, and “uplink” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes: receiving a configuration message that includes a sounding reference signal (SRS) configuration that indicates a first set of SRS transmission parameters for the UE; receiving an indication to modify the SRS configuration, wherein the indication is associated with a second set of SRS transmission parameters that is different from the first set of SRS transmission parameters; and transmitting one or more SRSs according to the second set of SRS transmission parameters and based at least in part on receiving the indication.

In some aspects, a method of wireless communication performed by a base station includes: transmitting a configuration message that includes an SRS configuration that indicates a first set of SRS transmission parameters for a UE; transmitting an indication to modify the SRS configuration, wherein the indication is associated with a second set of SRS transmission parameters that are different from the first set of SRS transmission parameters; and receiving one or more SRSs according to the second set of SRS transmission parameters and based at least in part on transmitting the indication.

In some aspects, a UE for wireless communication includes a memory and one or more processors coupled to the memory, the one or more processors configured to: receive a configuration message that includes an SRS configuration that indicates a first set of SRS transmission parameters for the UE; receive an indication to modify the SRS configuration, wherein the indication is associated with a second set of SRS transmission parameters that is different from the first set of SRS transmission parameters; and transmit one or more SRSs according to the second set of SRS transmission parameters and based at least in part on receiving the indication.

In some aspects, a base station for wireless communication includes a memory and one or more processors coupled to the memory, the one or more processors configured to: transmit a configuration message that includes an SRS configuration that indicates a first set of SRS transmission parameters for a UE; transmit an indication to modify the SRS configuration, wherein the indication is associated with a second set of SRS transmission parameters that are different from the first set of SRS transmission parameters; and receive one or more SRSs according to the second set of SRS transmission parameters and based at least in part on transmitting the indication.

In some aspects, a non-transitory computer-readable medium storing a set of instructions for wireless communication includes one or more instructions that, when executed by one or more processors of a UE, cause the UE to: receive a configuration message that includes an SRS configuration that indicates a first set of SRS transmission parameters for the UE; receive an indication to modify the SRS configuration, wherein the indication is associated with a second set of SRS transmission parameters that is different from the first set of SRS transmission parameters; and transmit one or more SRSs according to the second set of SRS transmission parameters and based at least in part on receiving the indication.

In some aspects, a non-transitory computer-readable medium storing a set of instructions for wireless communication includes one or more instructions that, when executed by one or more processors of a base station, cause the base station to: transmit a configuration message that includes an SRS configuration that indicates a first set of SRS transmission parameters for a UE; transmit an indication to modify the SRS configuration, wherein the indication is associated with a second set of SRS transmission parameters that are different from the first set of SRS transmission parameters; and receive one or more SRSs according to the second set of SRS transmission parameters and based at least in part on transmitting the indication.

In some aspects, an apparatus for wireless communication includes: means for receiving a configuration message that includes an SRS configuration that indicates a first set of SRS transmission parameters for the apparatus; means for receiving an indication to modify the SRS configuration, wherein the indication is associated with a second set of SRS transmission parameters that is different from the first set of SRS transmission parameters; and means for transmitting one or more SRSs according to the second set of SRS transmission parameters and based at least in part on receiving the indication.

In some aspects, an apparatus for wireless communication includes: means for transmitting a configuration message that includes an SRS configuration that indicates a first set of SRS transmission parameters for a UE; means for transmitting an indication to modify the SRS configuration, wherein the indication is associated with a second set of SRS transmission parameters that are different from the first set of SRS transmission parameters; and means for receiving one or more SRSs according to the second set of SRS transmission parameters and based at least in part on transmitting the indication.

In some aspects, a method of wireless communication performed by a UE includes: receiving a configuration message that indicates multiple SRS configurations, wherein different SRS configurations, of the multiple SRS configurations, are associated with different respective sets of SRS transmission parameters; receiving an indication of an active SRS configuration of the multiple SRS configurations; and transmitting one or more SRSs according to a set of SRS transmission parameters associated with the active SRS configuration.

In some aspects, a method of wireless communication performed by a base station includes: transmitting, to a UE, a configuration message that indicates multiple SRS configurations, wherein different SRS configurations, of the multiple SRS configurations, are associated with different respective sets of SRS transmission parameters; transmitting an indication of an active SRS configuration of the multiple SRS configurations; and receiving one or more SRSs from the UE according to a set of SRS transmission parameters associated with the active SRS configuration.

In some aspects, a UE for wireless communication includes: a memory; and one or more processors coupled to the memory, the one or more processors configured to: receive a configuration message that indicates multiple SRS configurations, wherein different SRS configurations, of the multiple SRS configurations, are associated with different respective sets of SRS transmission parameters; receive an indication of an active SRS configuration of the multiple SRS configurations; and transmit one or more SRSs according to a set of SRS transmission parameters associated with the active SRS configuration.

In some aspects, a base station for wireless communication includes: a memory; and one or more processors coupled to the memory, the one or more processors configured to: transmit, to a UE, a configuration message that indicates multiple SRS configurations, wherein different SRS configurations, of the multiple SRS configurations, are associated with different respective sets of SRS transmission parameters; transmit an indication of an active SRS configuration of the multiple SRS configurations; and receive one or more SRSs from the UE according to a set of SRS transmission parameters associated with the active SRS configuration.

In some aspects, a non-transitory computer-readable medium storing a set of instructions for wireless communication includes: one or more instructions that, when executed by one or more processors of a UE, cause the UE to: receive a configuration message that indicates multiple SRS configurations, wherein different SRS configurations, of the multiple SRS configurations, are associated with different respective sets of SRS transmission parameters; receive an indication of an active SRS configuration of the multiple SRS configurations; and transmit one or more SRSs according to a set of SRS transmission parameters associated with the active SRS configuration.

In some aspects, a non-transitory computer-readable medium storing a set of instructions for wireless communication includes: one or more instructions that, when executed by one or more processors of a base station, cause the base station to: transmit, to a UE, a configuration message that indicates multiple SRS configurations, wherein different SRS configurations, of the multiple SRS configurations, are associated with different respective sets of SRS transmission parameters; transmit an indication of an active SRS configuration of the multiple SRS configurations; and receive one or more SRSs from the UE according to a set of SRS transmission parameters associated with the active SRS configuration.

In some aspects, an apparatus for wireless communication includes: means for receiving a configuration message that indicates multiple SRS configurations, wherein different SRS configurations, of the multiple SRS configurations, are associated with different respective sets of SRS transmission parameters; means for receiving an indication of an active SRS configuration of the multiple SRS configurations; and means for transmitting one or more SRSs according to a set of SRS transmission parameters associated with the active SRS configuration.

In some aspects, an apparatus for wireless communication includes: means for transmitting, to a UE, a configuration message that indicates multiple SRS configurations, wherein different SRS configurations, of the multiple SRS configurations, are associated with different respective sets of SRS transmission parameters; means for transmitting an indication of an active SRS configuration of the multiple SRS configurations; and means for receiving one or more SRSs from the UE according to a set of SRS transmission parameters associated with the active SRS configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating an example of sounding reference signal (SRS) resource sets, in accordance with the present disclosure.

FIG. 5 is a diagram illustrating an example associated with SRS configuration modification, in accordance with the present disclosure.

FIG. 6 is a diagram illustrating an example associated with dynamic switching of SRS configurations, in accordance with the present disclosure.

FIG. 7 is a diagram illustrating an example associated with SRS configuration modification and dynamic switching of SRS configurations, in accordance with the present disclosure.

FIGS. 8 and 9 are diagrams illustrating example processes associated with SRS configuration modification, in accordance with the present disclosure.

FIGS. 10 and 11 are diagrams illustrating example processes associated with dynamic switching of SRS configurations, in accordance with the present disclosure.

FIGS. 12-15 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

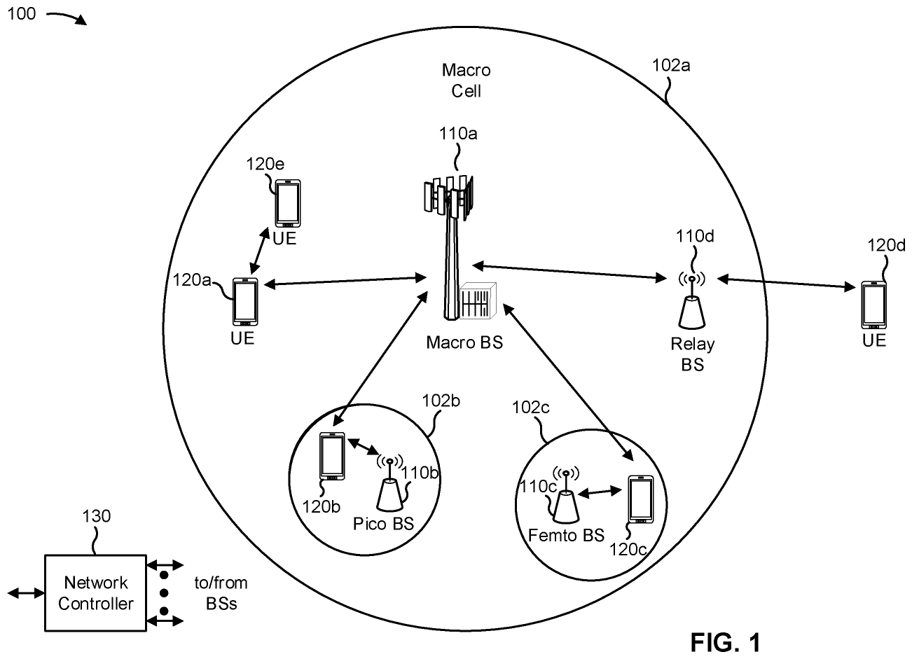

FIG. 1 is a diagram illustrating an example of a wireless network 100, in accordance with the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment. UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

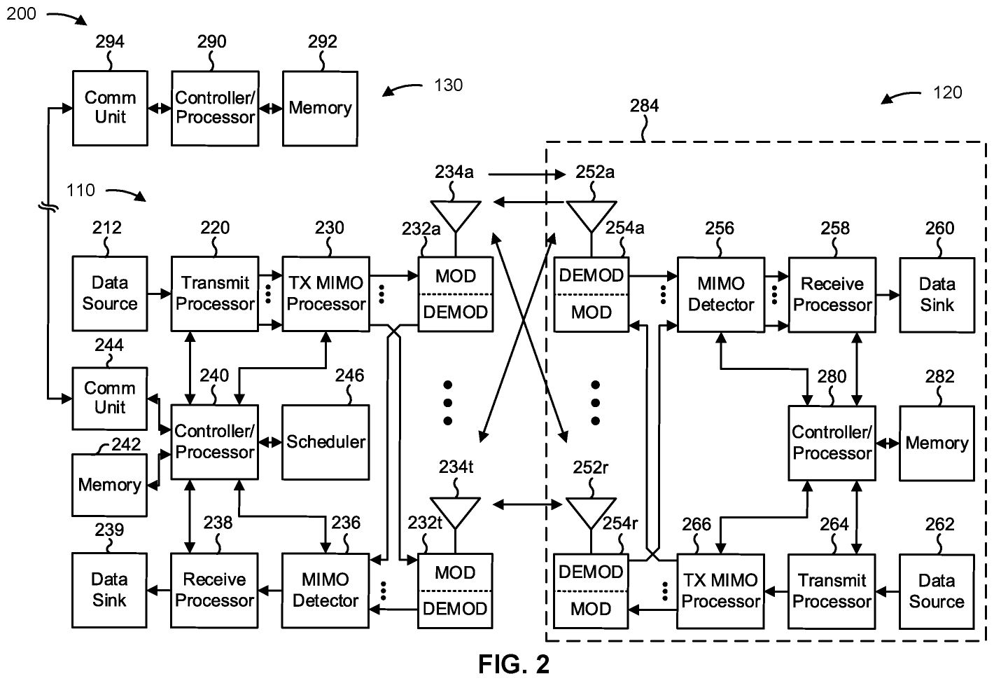

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to Tmodulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), CQI, and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

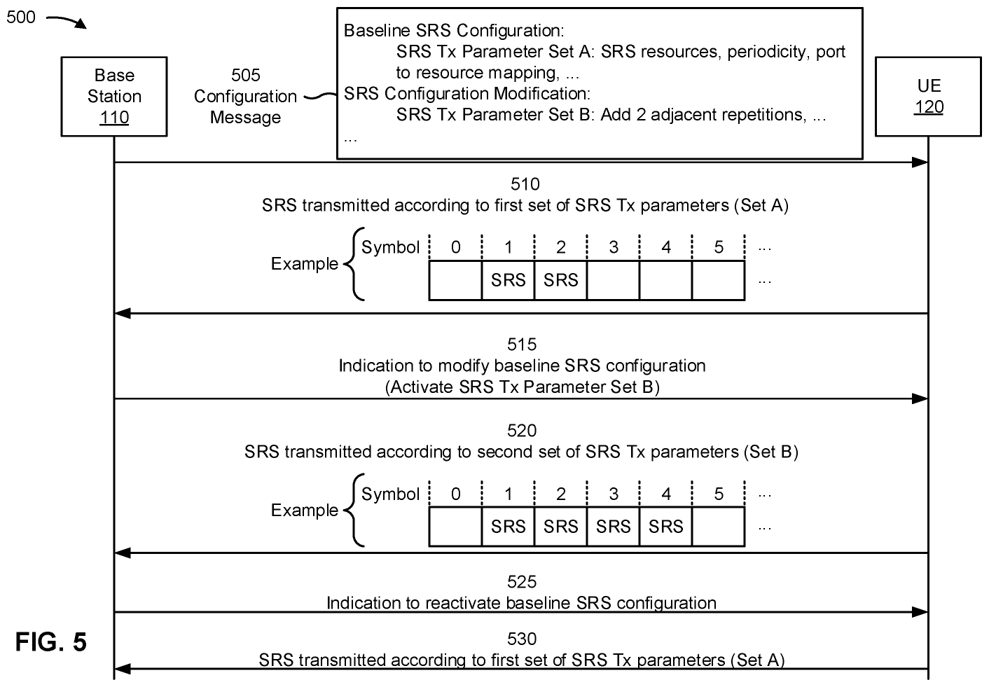

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5-11.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5-11.

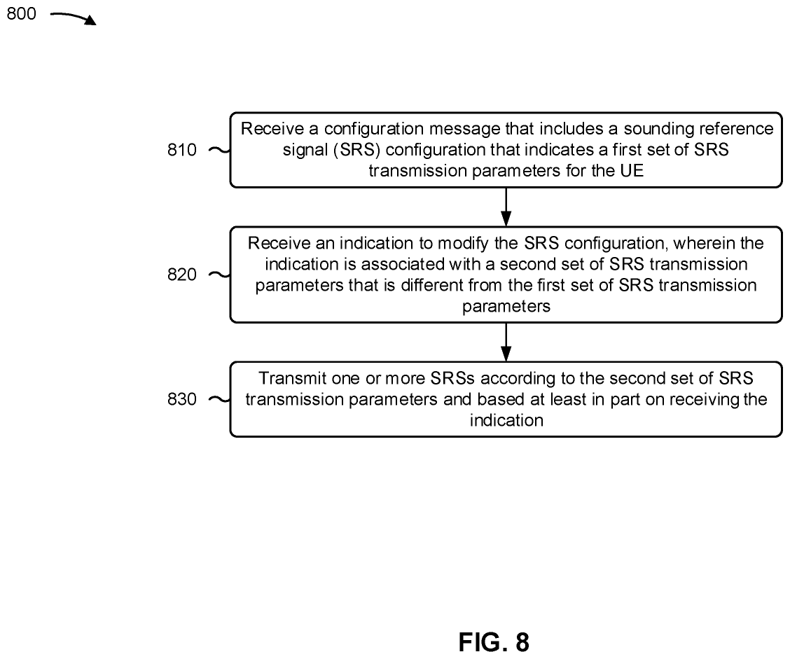

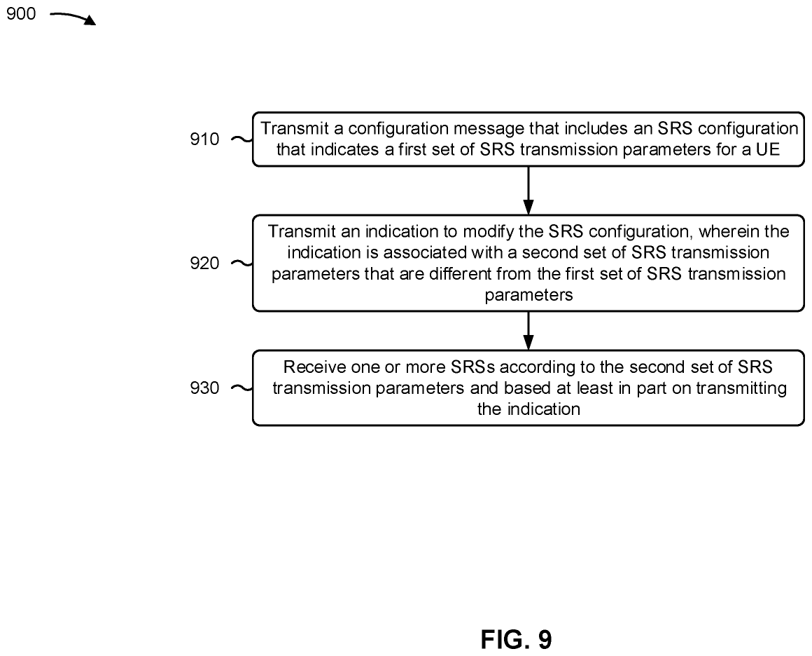

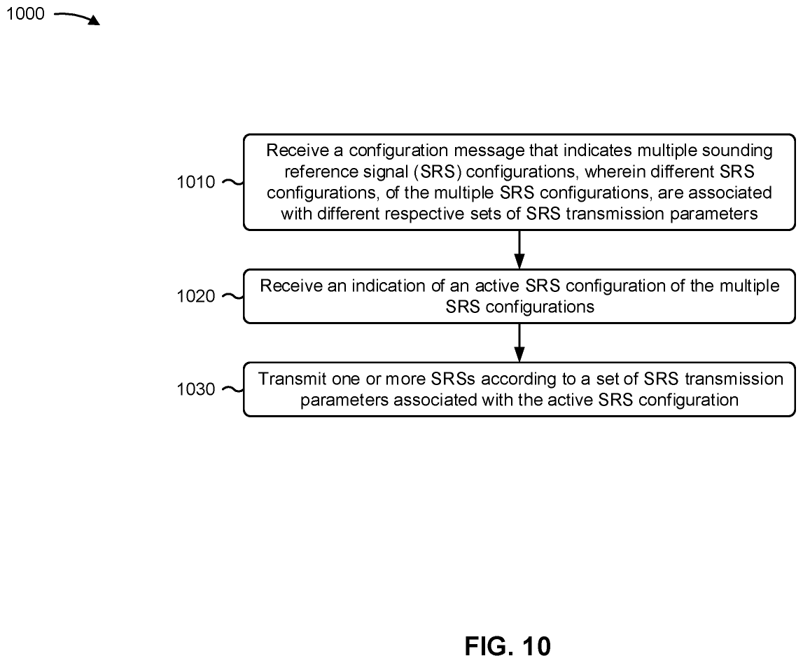

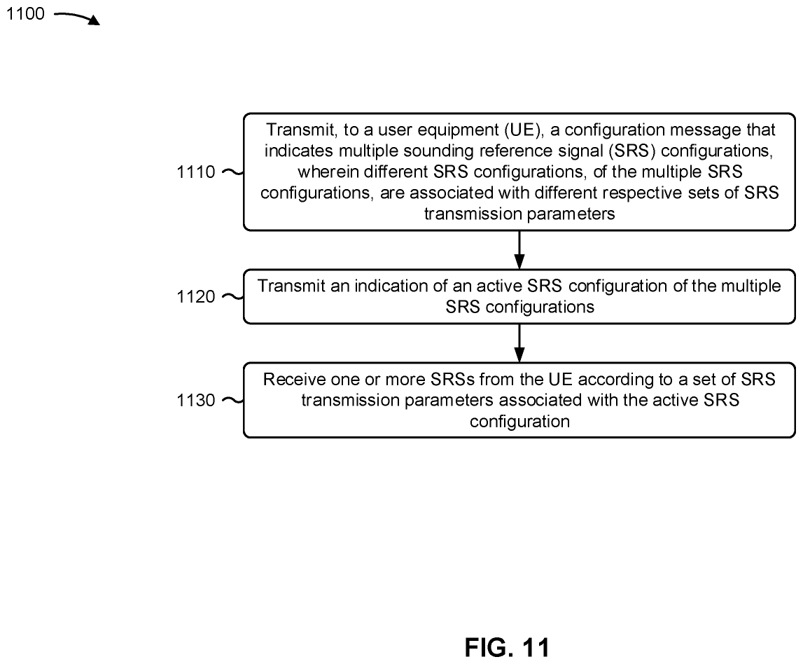

Controller/processor 240 of base station 110, controller/processor 280 of UE 120, and/or any other component(s) of FIG. 2 may perform one or more techniques associated with sounding reference signal (SRS) configuration modification, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some aspects, executing instructions may include running the instructions, converting the instructions, compiling the instructions, interpreting the instructions, and/or the like.

In some aspects, the UE includes means for receiving a configuration message that includes an SRS configuration that indicates a first set of SRS transmission parameters for the UE; means for receiving an indication to modify the SRS configuration, wherein the indication is associated with a second set of SRS transmission parameters that is different from the first set of SRS transmission parameters; and/or means for transmitting one or more SRSs according to the second set of SRS transmission parameters and based at least in part on receiving the indication. In some aspects, the UE includes means for receiving an indication to reactivate the SRS configuration indicated in the configuration message; and/or means for transmitting one or more SRSs according to the first set of SRS transmission parameters based at least in part on receiving the indication to reactivate the SRS configuration indicated in the configuration message. Such means may include, for example, antenna 252, demodulator 254, MIMO detector 256, receive processor 258, transmit processor 264, TX MIMO processor 266, modulator 254, controller/processor 280, and/or memory 282.

In some aspects, the base station includes means for transmitting a configuration message that includes an SRS configuration that indicates a first set of SRS transmission parameters for a UE; means for transmitting an indication to modify the SRS configuration, wherein the indication is associated with a second set of SRS transmission parameters that are different from the first set of SRS transmission parameters; and/or means for receiving one or more SRSs according to the second set of SRS transmission parameters and based at least in part on transmitting the indication. In some aspects, the base station includes means for transmitting an indication to reactivate the SRS configuration indicated in the configuration message; and means for receiving one or more SRSs according to the first set of SRS transmission parameters based at least in part on transmitting the indication to reactivate the SRS configuration indicated in the configuration message. Such means may include, for example, transmit processor 220, TX MIMO processor 230, modulator 232, antenna 234, demodulator 232, MIMO detector 236, receive processor 238, controller/processor 240, memory 242, and/or scheduler 246.

In some aspects, the UE includes means for receiving a configuration message that indicates multiple SRS configurations, wherein different SRS configurations, of the multiple SRS configurations, are associated with different respective sets of SRS transmission parameters; means for receiving an indication of an active SRS configuration of the multiple SRS configurations; and/or means for transmitting one or more SRSs according to a set of SRS transmission parameters associated with the active SRS configuration. Such means may include, for example, antenna 252, demodulator 254, MIMO detector 256, receive processor 258, transmit processor 264, TX MIMO processor 266, modulator 254, controller/processor 280, and/or memory 282.

In some aspects, the base station includes means for transmitting, to a UE, a configuration message that indicates multiple SRS configurations, wherein different SRS configurations, of the multiple SRS configurations, are associated with different respective sets of SRS transmission parameters; means for transmitting an indication of an active SRS configuration of the multiple SRS configurations; and/or means for receiving one or more SRSs from the UE according to a set of SRS transmission parameters associated with the active SRS configuration. Such means may include, for example, transmit processor 220, TX MIMO processor 230, modulator 232, antenna 234, demodulator 232, MIMO detector 236, receive processor 238, controller/processor 240, memory 242, and/or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

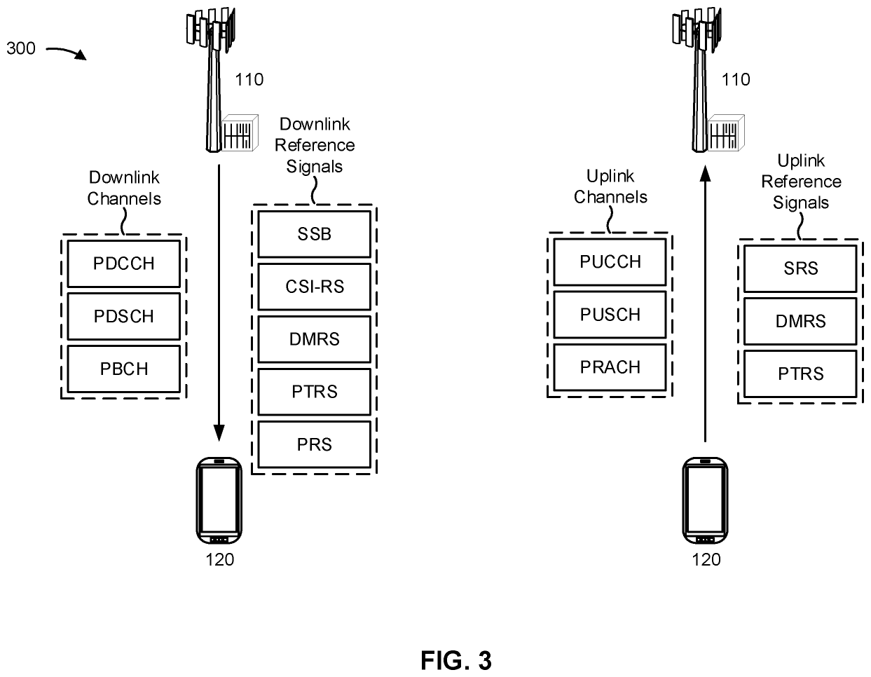

FIG. 3 is a diagram illustrating an example 300 of physical channels and reference signals in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

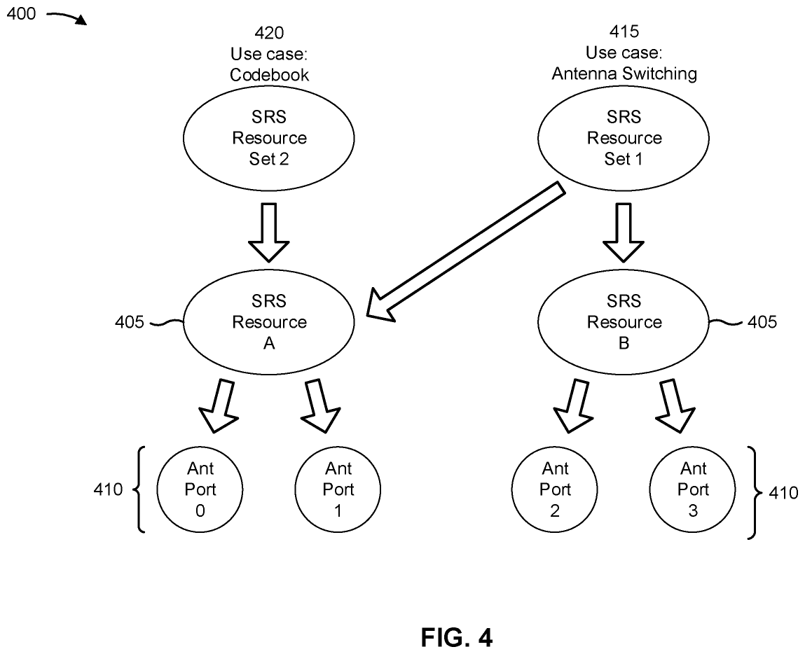

FIG. 4 is a diagram illustrating an example 400 of SRS resource sets, in accordance with the present disclosure.

A base station 110 may configure a UE 120 with one or more SRS resource sets to allocate resources for SRS transmissions by the UE 120. For example, a configuration for SRS resource sets may be indicated in a radio resource control (RRC) message (e.g., an RRC configuration message, an RRC reconfiguration message, and/or the like). As shown by reference number 405, an SRS resource set may include one or more resources (e.g., shown as SRS resources), which may include time resources and/or frequency resources (e.g., a slot, a symbol, a resource block, a periodicity for the time resources, and/or the like).

As shown by reference number 410, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, beam management, and/or the like.

An antenna switching SRS resource set may be used to indicate downlink CSI with reciprocity between an uplink and downlink channel. For example, when there is reciprocity between an uplink channel and a downlink channel, a base station 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a base station 110 indicates an uplink precoder to the UE 120. For example, when the base station 110 is configured to indicate an uplink precoder to the UE 120 (e.g., using a precoder codebook), the base station 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the base station 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the base station 110 indicated an uplink precoder to be used by the UE 120. For example, when the UE 120 is configured to select an uplink precoder, the base station 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the base station 110).

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X≤4). In some aspects, each of the X SRS ports may mapped to a corresponding symbol of the SRS resource and used for transmission of an SRS in that symbol.

As shown in FIG. 4, in some aspects, different SRS resource sets indicated to the UE 120 (e.g., having different use cases) may overlap (e.g., in time, in frequency, and/or the like, such as in the same slot). For example, as shown by reference number 415, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 420, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

When a UE 120 experiences poor channel conditions, such as in a coverage enhancement mode, the SRS configuration of the UE 120 may not be sufficient for the base station 110 to reliably obtain SRS from the UE 120 and estimate a channel to improve communication on the channel. In this case, a UE 120 could request a new SRS configuration (e.g., via an RRC reconfiguration procedure) that accounts for the poor channel conditions, and the base station 110 could transmit a new SRS configuration (e.g., in an RRC reconfiguration message). However, because the UE 120 is in poor channel conditions, the RRC reconfiguration procedure may have a reduced likelihood of success as compared to a likelihood of success if the UE 120 is in good channel conditions. Furthermore, this technique would result in additional signaling overhead.

Some techniques and apparatuses described herein enable a base station 110 to configure a UE 120 with an SRS configuration (e.g., when the UE 120 is in good channel conditions), and for the UE 120 to be configured with, hard-coded with, or signaled with a modification to the SRS configuration that can be applied by the UE 120 and the base station 110 at a later time (e.g., depending on channel conditions experienced by the UE 120 and/or the base station 110). For example, the UE 120 may use more SRS resources and/or a different SRS port mapping (e.g., to symbols of an SRS resource) when the UE 120 experiences or reports poor channel conditions. As a result, the base station 110 may be capable of better channel estimation and may use that better channel estimation to improve communications between the base station 110 and the UE 120. Furthermore, some techniques and apparatuses described herein enable a base station 110 to configure a UE 120 with multiple SRS configurations (e.g., when the UE 120 is in good channel conditions) and to dynamically switch between SRS configurations (e.g., depending on channel conditions experienced by the UE 120 and/or the base station 110). For example, the base station 110 could configure the UE 120 to use more SRS resources and/or a different SRS port mapping (e.g., to symbols of an SRS resource) when the UE 120 experiences or reports poor channel conditions. As a result, the base station 110 may be capable of better channel estimation and may use that better channel estimation to improve communications between the base station 110 and the UE 120.

As indicated above, FIG. 4 is provided as an example. Other examples may differ from what is described with regard to FIG. 4.

FIG. 5 is a diagram illustrating an example 500 associated with SRS configuration modification, in accordance with the present disclosure. As shown in FIG. 5, a base station 110 and a UE 120 may communicate with one another.

As show by reference number 505, the base station 110 may transmit, and the UE 120 may receive, a configuration message that indicates an SRS configuration. The SRS configuration may indicate a first set of SRS transmission parameters configured for the UE. The configured SRS configuration may sometimes be referred to as a default SRS configuration, a baseline SRS configuration, or the like. As shown, the first SRS configuration (shown as Baseline SRS Configuration) may be associated with a first set of SRS transmission parameters (shown as SRS Tx Parameter Set A). In some aspects, the SRS configuration is for periodic SRS transmissions. Alternatively, the SRS configuration may be for semi-persistent SRS transmissions.

A set of SRS transmission parameters may include one or more SRS transmission parameters. An SRS transmission parameter may include any configurable parameter that controls a manner in which the UE 120 generates and/or transmits an SRS. For example, an SRS transmission parameter may indicate an SRS resource on which the UE 120 is to transmit an SRS. Additionally, or alternatively, an SRS transmission parameter may indicate a number (e.g., a quantity) of SRS resources included in an SRS resource set configured by an SRS configuration.

Additionally, or alternatively, an SRS transmission parameter may indicate an SRS port used to transmit an SRS. Additionally, or alternatively, an SRS transmission parameter may indicate a number (e.g., a quantity) of SRS ports to be used by the UE 120 for SRS transmissions. Additionally, or alternatively, an SRS transmission parameter may indicate a mapping between SRS ports and SRS resources.

Additionally, or alternatively, an SRS transmission parameter may indicate a periodicity of an SRS resource (e.g., an SRS resource periodicity) and/or a slot offset of an SRS resource. Additionally, or alternatively, an SRS transmission parameter may indicate a number of symbols used for SRS transmission within a slot (e.g., 1, 2, or 4 symbols, which may be adjacent within the slot).

Additionally, or alternatively, an SRS transmission parameter may indicate an SRS repetition mode, such as whether SRS repetition is enabled or disabled. Additionally, or alternatively, an SRS transmission parameter may indicate a number of SRS repetitions to be transmitted by the UE 120 (e.g., 1 repetition, 2 repetitions, 4 repetitions, and so on).

In some aspects, the configuration message may activate the SRS configuration, and the base station 110 and the UE 120 may use that SRS configuration until another SRS configuration is indicated and/or activated. In this way, signaling ambiguities between the base station 110 and the UE 120 may be reduced, and channel estimation may be improved.

As further shown, in some aspects, the configuration message may indicate a modification to the SRS configuration (shown as SRS Configuration Modification) that is to be activated based at least in part on a signal from the base station 110 to the UE 120. The modification may include a modification to one or more SRS transmission parameters included in the set of SRS transmission parameters indicated in the SRS configuration. In some aspects, the modification may be a modification to a single SRS transmission parameter indicated in the SRS configuration. In some aspects, the modification may be a modification to multiple SRS transmission parameters indicated in the SRS configuration. The combination of the first set of SRS transmission parameters (e.g., indicated in the baseline SRS configuration) and the modification to one or more SRS transmission parameters, included in the first set, forms a second set of SRS transmission parameters. The UE 120 may use the second set of SRS transmission parameters based at least in part on receiving an indication from the base station 110 to modify the SRS configuration, as described in more detail below. In this way, signaling overhead associated with switching between SRS configurations (and different SRS transmission parameters) may be reduced.

In some aspects, the modification to the SRS configuration may indicate one or more different SRS resources, as compared to the first set of SRS transmission parameters, to be used by the UE 120 for SRS transmission. Additionally, or alternatively, the modification to the SRS configuration may indicate a different number (e.g., a different quantity) of SRS resources, as compared to the first set of SRS transmission parameters, to be used by the UE 120 for SRS transmission.

Additionally, or alternatively, the modification to the SRS configuration may indicate one or more different SRS ports, as compared to the first set of SRS transmission parameters, to be used by the UE 120 for SRS transmission. Additionally, or alternatively, the modification to the SRS configuration may indicate a different number (e.g., a different quantity) of SRS ports, as compared to the first set of SRS transmission parameters, to be used by the UE 120 for SRS transmission. Additionally, or alternatively, the modification to the SRS configuration may indicate a different mapping of SRS ports to SRS resources as compared to the first set of SRS transmission parameters.

Additionally, or alternatively, the modification to the SRS configuration may indicate a different periodicity for SRS transmission (e.g., for an SRS resource) as compared to the first set of SRS transmission parameters. Additionally, or alternatively, the modification to the SRS configuration may indicate a different slot offset for an SRS resource as compared to the first set of SRS transmission parameters. Additionally, or alternatively, the modification to the SRS configuration may indicate a different number (e.g., a different quantity) of symbols, as compared to the first set of SRS transmission parameters, to be used by the UE 120 for SRS transmission within a slot.

Additionally, or alternatively, the modification to the SRS configuration may indicate a different SRS repetition mode (e.g., enabled or disabled) as compared to the first set of SRS transmission parameters. Additionally, or alternatively, the modification to the SRS configuration may indicate a different number (e.g., a different quantity) of SRS repetitions as compared to the first set of SRS transmission parameters.

Although a single SRS configuration modification is shown in FIG. 5, in some aspects, the base station 110 may configure multiple different SRS configuration modifications that can be applied to a baseline SRS configuration. In some aspects, the base station 110 may indicate which modification, of multiple configured modifications, to apply to the baseline SRS configuration. The indication of which modification to apply may be signaled in the message described below in connection with reference number 515.

Furthermore, although the modification is described in connection with FIG. 5 as being transmitted in the configuration message, the modification may be indicated in a different manner. For example, the modification may be included in a message and/or an indication that instructs the UE 120 to modify the SRS configuration, such as the message and/or the indication described below in connection with reference number 515. Additionally, or alternatively, the modification may be defined in a wireless communication standard. In this case, the modification (e.g. instructions for modifying a baseline SRS configuration) may be stored in memory of the UE 120 without the UE 120 receiving the modification from the base station 110 and/or from another device.

As shown by reference number 510, the UE 120 may transmit one or more SRSs according to a first set of SRS transmission parameters (e.g., an active set of SRS transmission parameters). In example 500, the configuration message configures a baseline SRS configuration associated with a first set of SRS transmission parameters (Set A), and the UE 120 transmits SRSs according to the baseline SRS configuration (e.g., using the first set of SRS transmission parameters). In example 500, the baseline SRS configuration indicates that the UE 120 is to transmit SRSs in symbols 1 and 2 within a slot. The base station 110 may monitor for the one or more SRSs according to the first set of SRS transmission parameters.

As shown by reference number 515, the base station 110 may transmit, and the UE 120 may receive, an indication to modify the SRS configuration (e.g., the baseline SRS configuration). The indication may be associated with a second set of SRS transmission parameters that is different from the first set of SRS transmission parameters. For example, based at least in part on the indication, the base station 110 and the UE 120 may apply the modification to the first set of SRS transmission parameters, resulting in a second set of SRS transmission parameters.

In example 500, during a time period when the baseline SRS configuration is active, the base station 110 transmits a message to modify the baseline SRS configuration to activate a second set of SRS transmission parameters (shown as Set B). This message may include, for example, a message that includes an indication to activate a coverage enhancement mode for the UE 120. Additionally, or alternatively, the message may include a DCI and/or a MAC-CE, among other examples. The DCI may be UE-specific DCI or group common DCI (GC-DCI). The UE-specific DCI may be transmitted to and/or decoded by only the UE 120, while GC-DCI may be transmitted to and/or decoded by a group of UEs that includes the UE 120. In some aspects, if the indication is transmitted in GC-DCI, different fields may be used for different UEs so that different index values (e.g., that correspond to different SRS configuration modifications and/or different second sets of SRS transmission parameters) can be indicated for different UEs. Additionally, or alternatively, multiple UEs may obtain the indication (e.g., an index value) from the same field of the GC-DCI but may interpret the indication differently depending on the configuration message. For example, a particular index value in a field may map to a first modification to a baseline SRS configuration for a first UE and may map to a second modification (which may be different from the first medication) to a baseline SRS configuration for a second UE (which may be different from the baseline SRS configuration for the first UE).

In some aspects, the base station 110 may transmit the indication based at least in part on determining that the UE 120 is associated with poor channel conditions. For example, the base station 110 may determine that the UE 120 is operating in, or is to be signaled to operate in, a coverage enhancement mode. In this way, the base station 110 may dynamically instruct the UE 120 to switch an SRS configuration, which may improve reliability when the UE 120 is in poor channel conditions and may reduce SRS signaling overhead when the UE 120 is in good channel conditions.

In some aspects, if the SRS configuration is for semi-persistent SRS transmissions, the base station 110 may transmit the indication during a time period when semi-persistent SRS transmissions are activated, and the modification may be applied to the SRS configuration associated with the activated semi-persistent SRS transmissions. For example, the base station 110 may configure (e.g., using the configuration message) one or more semi-persistent SRS configurations that may be dynamically activated and deactivated. A particular semi-persistent SRS configuration may be configured with a baseline SRS configuration and one or more modifications, as described above in connection with reference number 505. To cause a modification to the baseline SRS configuration for a particular semi-persistent SRS configuration, the base station 110 may transmit the indication to modify the baseline SRS configuration while that particular semi-persistent SRS configuration is active. Additionally, or alternatively, the base station 110 may transmit the indication to modify the baseline SRS configuration in a message that activates that particular semi-persistent SRS configuration (e.g., in activation DCI or in an activation MAC-CE).

As shown by reference number 520, based at least in part on receiving the message (e.g., after receiving the message), the UE 120 may transmit one or more SRSs according to a second set of SRS transmission parameters, which may be formed by modifying the first set of SRS transmission parameters according to the indicated modification. In example 500, the indication from the base station 110 instructs the UE 120 to modify the baseline SRS configuration according to the indicated modification, and the UE 120 transmits SRSs according to a resulting SRS configuration (e.g., using a second set of SRS transmission parameters). In example 500, the modification indicates that the UE 120 is to transmit SRSs in symbols 1, 2, 3, and 4 within a slot. In example 500, the additional SRS transmissions in symbols 3 and 4 are repetitions of the SRS transmissions in symbols 1 and 2, respectively. However, in some aspects, the SRS transmissions in symbols 3 and 4 may be distinct SRS transmissions (e.g., transmitted using different SRS ports and/or SRS sequences) from the SRS transmissions in symbols 1 and 2 based at least in part on the configuration and/or the modification. The base station 110 may monitor for the one or more SRSs according to the second set of SRS transmission parameters.

In some aspects, the first set of SRS transmission parameters indicates a first set of SRS resources, and the modification indicates one or more SRS resources that are not included in the first set of SRS resources. For example, in example 500, the first set of SRS transmission parameters indicates an SRS resource in symbols 1 and 2 of a slot, and the modification indicates an SRS resource in symbols 3 and 4 of the slot. In this case, the second set of SRS transmission parameters includes the first set of SRS resources indicated in the baseline SRS configuration and the one or more SRS resources indicated by the modification, resulting in SRS transmissions in symbols 1, 2, 3, and 4. In some aspects, the one or more SRS resources (e.g., additional SRS resources indicated by the modification) have the same periodicity as the first set of SRS resources, as configured by the baseline SRS configuration. In this case, the periodicity need not be signaled more than once, thereby conserving signaling overhead. In this way, the UE 120 may transmit more SRSs for better channel estimation when the UE 120 is in a poor channel condition (e.g., a coverage enhancement mode).

In some aspects, the first set of SRS transmission parameters indicates a first periodicity for SRS resources, and the modification indicates a second periodicity that is different from the first periodicity. In some aspects, the same number and/or time domain locations of SRS resources may be used within a slot after modification of the first set of SRS transmission parameters, but those SRS resources may occur more frequently due to a smaller periodicity indicated by the modification. In this case, the second set of SRS transmission parameters includes a set of SRS resources indicated in the baseline SRS configuration, but transmitted more frequently (e.g., with a smaller periodicity) as compared to the baseline SRS configuration. In this case, different SRS resources, numbers of SRS resources, and/or symbols for SRS resources need not be signaled more than once, thereby conserving signaling overhead. In this way, the UE 120 may transmit SRSs more often for better channel estimation when the UE 120 is in a poor channel condition (e.g., a coverage enhancement mode).

In some aspects, the first set of SRS transmission parameters indicates a smaller number of symbols to be used for SRS transmission within a slot as compared to the second set of SRS transmission parameters. For example, the first set of SRS transmission parameters may indicate two symbols for SRS transmission per slot in which SRSs are transmitted (e.g., symbols 1 and 2), and the modification may indicate four symbols for SRS transmission per slot in which SRSs are transmitted (e.g., symbols 1, 2, 3, and 4). In some aspects, the same starting symbol may be used for the modified SRS configuration such that the starting symbol need not be signaled, and only the difference in number of symbols needs to be signaled (e.g., where the symbols are adjacent or consecutive). In this way, the UE 120 may transmit more SRSs for better channel estimation when the UE 120 is in a poor channel condition (e.g., a coverage enhancement mode).

In some aspects, the first SRS configuration indicates a set of SRS resources (e.g., that spans symbols 1 and 2), and the second SRS configuration indicates (e.g., activates) one or more repetitions of the set of SRS resources (e.g., repetitions on symbols 3 and 4). In some aspects, the one or more repetitions (e.g., on symbols 3 and 4) may occur in the same slot as the initial SRS transmissions (e.g., on symbols 1 and 2), as shown in FIG. 5. Alternatively, the one or more repetitions may occur in a different slot as the initial SRS transmissions (e.g., an adjacent slot or a non-adjacent slot). In this way, the UE 120 may repeat SRSs for better channel estimation when the UE 120 is in a poor channel condition (e.g., a coverage enhancement mode).

In some aspects, the first SRS configuration indicates a first quantity of SRS ports, and the modification indicates a second quantity of SRS ports. In some aspects, the first quantity of SRS ports is greater than the second quantity of SRS ports. Additionally, or alternatively, the first SRS configuration may indicate a first mapping between SRS ports and SRS resources (e.g., symbols for SRS transmission), and the modification may indicate a second mapping that is different from the first mapping. In this way, the UE 120 can transmit SRSs on a smaller number of SRS ports that have better performance, resulting in better channel estimation when the UE 120 is in a poor channel condition (e.g., a coverage enhancement mode).

As shown by reference number 525, in some aspects, the base station 110 may transmit, and the UE 120 may receive, an indication to reactivate the SRS configuration indicated in the configuration message (e.g., the baseline SRS configuration). For example, the base station 110 may determine that the UE 120 is operating with good channel conditions and/or that a coverage enhancement mode is to be deactivated for the UE 120. Based at least in part on this determination, the base station 110 may transmit the indication to reactivate the baseline SRS configuration. The indication may be included in DCI (e.g., UE-specific DCI or GC-DCI), a MAC-CE, and/or a message that includes an indication to deactivate a coverage enhancement mode for the UE 120, among other examples. In some aspects, the GC-DCI may include different fields for different UEs or different subsets of UEs, and a particular field may indicate whether to reactivate the baseline SRS configuration or use the modified SRS configuration (e.g., the modification to the baseline SRS configuration).

As shown by reference number 530, based at least in part on receiving the indication to reactivate the baseline SRS configuration, the UE 120 may transmit one or more SRSs according to the first set of SRS transmission parameters, in a similar manner as described above in connection with reference number 510. Similarly, the base station 110 may monitor for the one or more SRSs according to the first set of SRS transmission parameters based at least in part on transmitting the indication to reactivate the baseline SRS configuration.

By enabling a base station 110 to configure a UE 120 with an SRS configuration and one or more modifications to the SRS configuration and to dynamically switch between different sets of SRS transmission parameters (e.g., depending on channel conditions experienced by the UE 120 and/or the base station 110), the base station 110 may improve a reliability with which SRS transmissions are received from the UE 120 when the UE 120 is operating in poor channel conditions. Furthermore, the base station 110 may reduce SRS signaling overhead and conserve network resources when the UE 120 is operating in good channel conditions. This technique of dynamic switching between SRS configurations requires less signaling overhead in a dynamic indication than indicating an entire set of SRS transmission parameters in a dynamic indication. Furthermore, because the dynamic indication is likely to be transmitted when the UE 120 is in poor channel conditions, a short message indicating that the UE 120 is to switch between configured SRS configurations is more likely to be successfully received by the UE 120 than a long message indicating an entire set of SRS transmission parameters to be activated for the UE 120.

As indicated above, FIG. 5 is provided as an example. Other examples may differ from what is described with respect to FIG. 5.

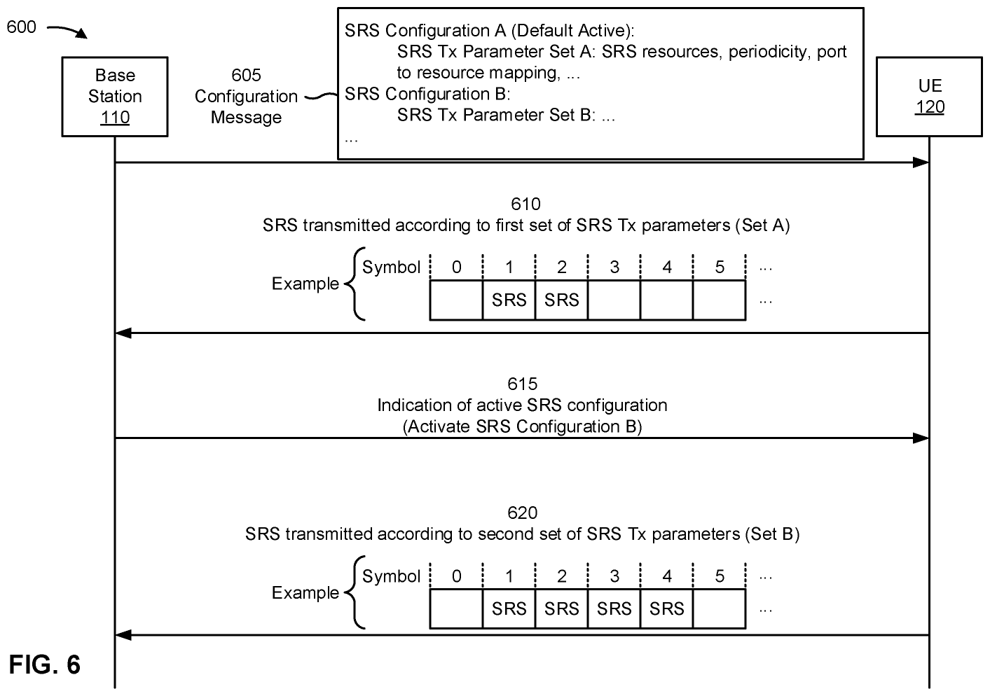

FIG. 6 is a diagram illustrating an example 600 associated with dynamic switching of SRS configurations, in accordance with the present disclosure. As shown in FIG. 6, a base station 110 and a UE 120 may communicate with one another.

As show by reference number 605, the base station 110 may transmit, and the UE 120 may receive, a configuration message that indicates multiple SRS configurations. As further shown, different SRS configurations, of the multiple SRS configurations, may be associated with different respective sets of SRS transmission parameters. For example, a first SRS configuration (shown as SRS Configuration A) may be associated with a first set of SRS transmission parameters (shown as SRS Tx Parameter Set A), and a second SRS configuration (shown as SRS Configuration B) may be associated with a second set of SRS transmission parameters (shown as SRS Tx Parameter Set B). Although aspects are described herein in connection with two SRS configurations and two corresponding sets of SRS transmission parameters, the multiple SRS configurations may include more than two SRS configurations in some aspects. In some aspects, the multiple SRS configurations may be for periodic SRS transmissions. Alternatively, the multiple SRS configurations may be for semi-persistent SRS transmissions.

A set of SRS transmission parameters may include one or more SRS transmission parameters. An SRS transmission parameter may include any configurable parameter that controls a manner in which the UE 120 transmits an SRS. For example, an SRS transmission parameter may indicate an SRS resource on which the UE 120 is to transmit an SRS. In this case, different sets of SRS transmission parameters may configure different SRS resources. Additionally, or alternatively, an SRS transmission parameter may indicate a number (e.g., a quantity) of SRS resources included in an SRS resource set configured by an SRS configuration. In this case, different sets of SRS transmission parameters may configure different numbers or quantities of SRS resources.

Additionally, or alternatively, an SRS transmission parameter may indicate an SRS port used to transmit an SRS. In this case, different sets of SRS transmission parameters may configure different SRS ports to be used for SRS transmission. Additionally, or alternatively, an SRS transmission parameter may indicate a number (e.g., a quantity) of SRS ports to be used by the UE 120 for SRS transmissions. In this case, different sets of SRS transmission parameters may configure different numbers or quantities of SRS ports. Additionally, or alternatively, an SRS transmission parameter may indicate a mapping between SRS ports and SRS resources. In this case, different sets of SRS transmission parameters may configure different mappings between SRS ports and SRS resources.

Additionally, or alternatively, an SRS transmission parameter may indicate a periodicity of an SRS resource (e.g., an SRS resource periodicity) and/or a slot offset of an SRS resource. In this case, different sets of SRS transmission parameters may configure different periodicities for SRS transmission and/or different slot offsets for an SRS resource. Additionally, or alternatively, an SRS transmission parameter may indicate a number of symbols used for SRS transmission within a slot (e.g., 1, 2, or 4 symbols, which may be adjacent within the slot). In this case, different sets of SRS transmission parameters may configure different numbers of symbols for SRS transmission within a slot.

Additionally, or alternatively, an SRS transmission parameter may indicate an SRS repetition mode, such as whether SRS repetition is enabled or disabled. In this case, different sets of SRS transmission parameters may configure different SRS repetition modes (e.g., SRS repetition may be enabled by a first SRS configuration and disabled by a second SRS configuration). Additionally, or alternatively, an SRS transmission parameter may indicate a number of SRS repetitions to be transmitted by the UE 120 (e.g., 1 repetition, 2 repetitions, 4 repetitions, and so on). In this case, different sets of SRS transmission parameters may configure different numbers of SRS repetitions.

As indicated above, different SRS configurations, included in the configuration message, may be associated with different respective sets of SRS transmission parameters. For example, all of the SRS transmission parameters of a first SRS configuration may be different from corresponding SRS transmission parameters of a second SRS configuration. Alternatively, a first SRS configuration and a second SRS configuration may include one or more SRS transmission parameters that are the same and may include one or more SRS transmission parameters that are different. In some aspects, at least one SRS transmission parameter is different between different SRS configurations included in the configuration message.

As further shown in FIG. 6, in some aspects, the configuration message may indicate one of the SRS configurations, of the multiple SRS configurations, that is active (show as Default Active for SRS Configuration A). In some aspects, only one of the SRS configurations, of the multiple SRS configurations, is permitted to be active at a particular time. The configuration message may activate one of the SRS configurations, and the base station 110 and the UE 120 may use that SRS configuration until another SRS configuration is activated. In this way, signaling ambiguities between the base station 110 and the UE 120 may be reduced, and channel estimation may be improved.

As shown by reference number 610, the UE 120 may transmit one or more SRSs according to a first set of SRS transmission parameters (e.g., an active set of SRS transmission parameters). In example 600, the configuration message indicates that SRS Configuration A is active, and the UE 120 transmits SRSs according to SRS Configuration A. In example 600, SRS Configuration A indicates that the UE 120 is to transmit SRSs in symbols 1 and 2 within a slot. The base station 110 may monitor for the one or more SRSs according to the first set of SRS transmission parameters.

As shown by reference number 615, the base station 110 may transmit, and the UE 120 may receive, an indication of an active SRS configuration. The indication may indicate an SRS configuration that is different from an SRS configuration that is currently active. In example 600, while SRS Configuration A is active, the base station 110 transmits a message to activate SRS Configuration B. This message may include, for example, DCI, a MAC-CE, and/or the like. The DCI may be UE-specific DCI or GC-DCI. The UE-specific DCI may be transmitted to and/or decoded by only the UE 120, while GC-DCI may be transmitted to and/or decoded by a group of UEs that includes the UE 120. In some aspects, if the indication is transmitted in GC-DCI, different fields may be used for different UEs so that different index values (e.g., that correspond to different SRS configurations) can be indicated for different UEs. Additionally, or alternatively, multiple UEs may obtain the indication (e.g., an index value) from the same field of the GC-DCI but may interpret the indication differently depending on the configuration message. For example, a particular index value in a field may map to one SRS configuration for a first UE and may map to a different SRS configuration for a second UE.

In some aspects, the base station 110 may transmit the indication based at least in part on determining that the UE 120 is associated with poor channel conditions. For example, the base station 110 may determine that the UE 120 is operating in or is to be signaled to operate in a coverage enhancement mode. In this way, the base station 110 may dynamically instruct the UE 120 to switch an SRS configuration, which may improve reliability when the UE 120 is in poor channel conditions and may reduce SRS signaling overhead when the UE 120 is in good channel conditions.

In some aspects, if the SRS configurations are for semi-persistent SRS transmissions, the base station 110 may transmit the indication during a time period when semi-persistent SRS transmissions are activated, and the SRS configuration indicated in the indication may apply to activated semi-persistent SRS transmissions. For example, the base station 110 may configure (e.g., using the configuration message) one or more semi-persistent SRS configurations that may be dynamically activated and deactivated. A particular semi-persistent SRS configuration may be configured with multiple SRS configuration options, such as the SRS configurations described above in connection with reference number 605. To indicate a switch between SRS configurations for a particular semi-persistent SRS configuration, the base station 110 may transmit the indication of the switch while that particular semi-persistent SRS configuration is active. Additionally, or alternatively, the base station 110 may transmit the indication of the switch in a message that activates that particular semi-persistent SRS configuration (e.g., in activation DCI or in an activation MAC-CE).

As shown by reference number 620, based at least in part on receiving the message (e.g., after receiving the message), the UE 120 may transmit one or more SRSs according to a second set of SRS transmission parameters (e.g., an active set of SRS transmission parameters). In example 600, the indication from the base station 110 indicates that SRS Configuration B is active, and the UE 120 transmits SRSs according to SRS Configuration B. In example 600, SRS Configuration B indicates that the UE 120 is to transmit SRSs in symbols 1, 2, 3, and 4 within a slot. SRS transmission in these symbols may be distinct SRS transmissions (e.g., transmitted using different SRS ports), or the SRS transmissions in symbols 3 and 4 may be repetitions of the SRS transmission in symbols 1 and 2, respectively, depending on the second set of SRS transmission parameters. The base station 110 may monitor for the one or more SRSs according to the second set of SRS transmission parameters.

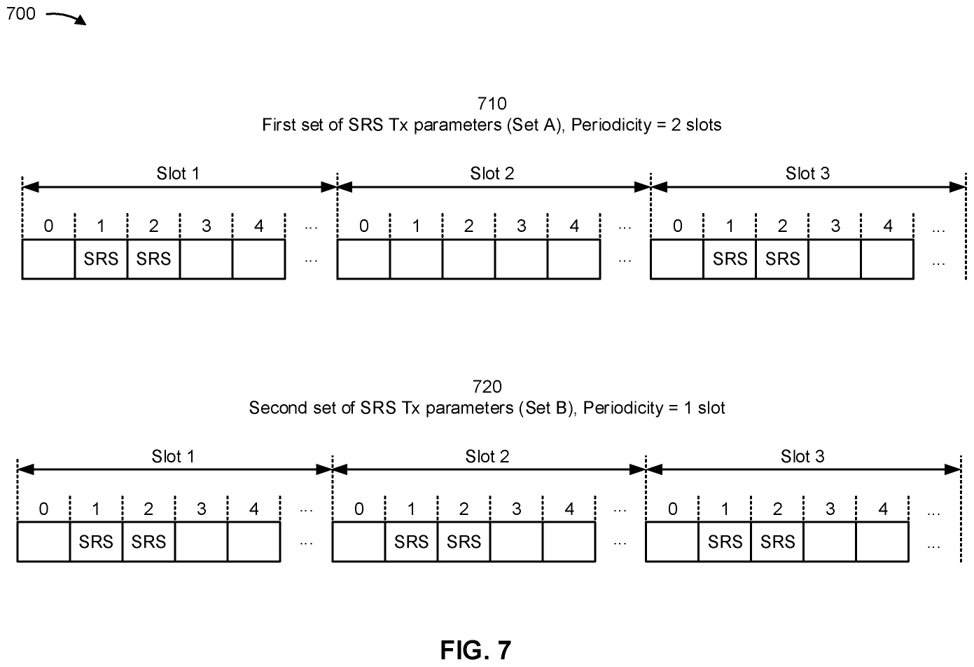

In some aspects, the first SRS configuration indicates a set of SRS resources (e.g., that spans symbols 1 and 2), and the second SRS configuration indicates one or more repetitions of the set of SRS resources (e.g., repetitions on symbols 3 and 4). In some aspects, the repetitions (e.g., on symbols 3 and 4) may occur in the same slot as the initial SRS transmissions (e.g., on symbols 1 and 2), as shown in FIG. 6. Alternatively, the repetitions may occur in a different slot as the initial SRS transmissions (e.g., an adjacent slot or a non-adjacent slot), as described in more detail below in connection with FIG. 7.

By enabling a base station 110 to configure a UE 120 with multiple SRS configurations and to dynamically switch between SRS configurations (e.g., depending on channel conditions experienced by the UE 120 and/or the base station 110), the base station 110 may improve a reliability with which SRS transmission are received from the UE 120 when the UE 120 is operating in poor channel conditions. Furthermore, the base station 110 may reduce SRS signaling overhead and conserve network resources when the UE 120 is operating in good channel conditions. This technique of dynamic switching between SRS configurations requires less signaling overhead in a dynamic indication than indicating an entire set of SRS transmission parameters in a dynamic indication. Furthermore, because the dynamic indication is likely to be transmitted when the UE 120 is in poor channel conditions, a short message indicating that the UE 120 is to switch between configured SRS configurations is more likely to be successfully received by the UE 120 than a long message indicating an entire set of SRS transmission parameters to be activated for the UE 120.

As indicated above, FIG. 6 is provided as an example. Other examples may differ from what is described with respect to FIG. 6.

FIG. 7 is a diagram illustrating an example 700 associated with SRS configuration modification, in accordance with the present disclosure.

As shown in FIG. 7, a baseline SRS configuration may indicate a set of SRS resources having a first periodicity, and a modification to the baseline SRS configuration may indicate a second periodicity that is different from the first periodicity. For example, as shown by reference number 710, a first SRS configuration may include a first set of SRS transmission parameters that indicates a set of SRS resources in symbols 1 and 2 of a slot, with a periodicity of two slots, such that SRS transmissions are configured in symbols 1 and 2 of Slot 1, symbols 1 and 2 of Slot 3, and so on.

As shown by reference number 720, a modification to the baseline SRS configuration may indicate a second periodicity, shown as a periodicity of one slot, such that SRS transmissions are configured in symbols 1 and 2 of Slot 1, symbols 1 and 2 of Slot 2, symbols 1 and 2 of Slot 3, and so on. In this case, one or more of the SRS transmission parameters indicated in the baseline SRS configuration may be reused, such as a number of symbols configured for SRS transmissions within a slot (e.g., two symbols, as shown), the particular symbols configured for SRS transmissions within a slot (e.g., symbols 1 and 2), and/or a slot offset, among other examples.

In some aspects, the additional SRS transmissions indicated by the modification may be repetitions of the SRS transmissions indicated in the baseline SRS configuration. Alternatively, the additional SRS transmissions may be distinct SRS transmissions (e.g., not repetitions).

As another example, a first SRS configuration may indicate a set of SRS resources, and a second SRS configuration may indicate one or more repetitions of the set of SRS resources. For example, as shown by reference number 710, a first SRS configuration may include a first set of SRS transmission parameters that indicates a set of SRS resources in symbols 1 and 2 of Slot 1. The first set of SRS transmission parameters may also indicate a periodicity of two slots, such that SRS transmissions are configured in symbols 1 and 2 of Slot 1, symbols 1 and 2 of Slot 3, and so on. As shown by reference number 720, a second SRS configuration may include a second set of SRS transmission parameters that indicates repetition of the set of SRS resources, indicated in the first set of SRS transmission parameters, in symbols 1 and 2 of Slot 2. In this case, the UE 120 may repeat the SRS transmissions in symbols 1 and 2 of Slot 1 in symbols 1 and 2 of Slot 2.

As described above, the techniques and apparatuses described herein enable improved reliability of SRS transmissions when the UE 120 is operating in poor channel conditions. Furthermore, the techniques and apparatuses described herein reduce SRS signaling overhead and conserve network resources when the UE 120 is operating in good channel conditions.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with SRS configuration modification.

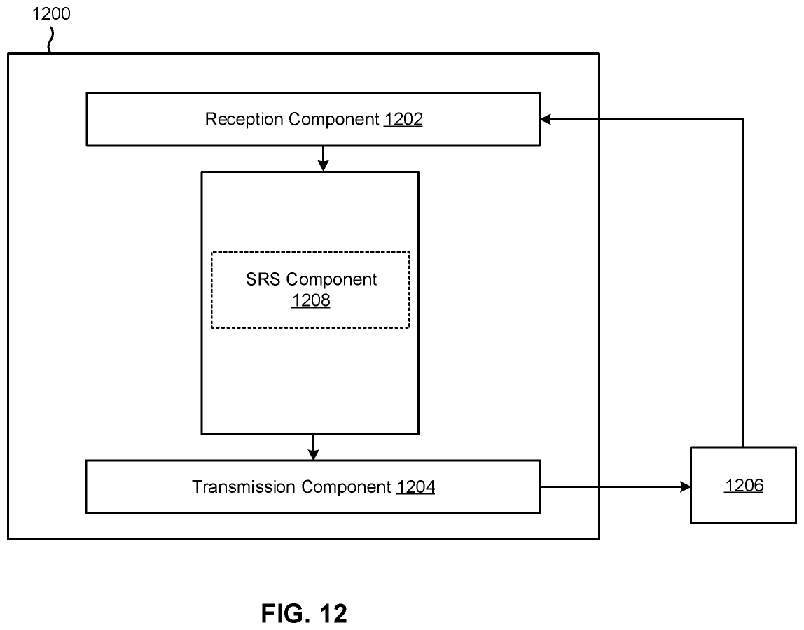

As shown in FIG. 8, in some aspects, process 800 may include receiving a configuration message that includes an SRS configuration that indicates a first set of SRS transmission parameters for the UE (block 810). For example, the UE (e.g., using reception component 1202, depicted in FIG. 12) may receive a configuration message that includes an SRS configuration that indicates a first set of SRS transmission parameters for the UE, as described above.

As further shown in FIG. 8, in some aspects, process 800 may include receiving an indication to modify the SRS configuration, wherein the indication is associated with a second set of SRS transmission parameters that is different from the first set of SRS transmission parameters (block 820). For example, the UE (e.g., using reception component 1202, depicted in FIG. 12) may receive an indication to modify the SRS configuration, wherein the indication is associated with a second set of SRS transmission parameters that is different from the first set of SRS transmission parameters, as described above.

As further shown in FIG. 8, in some aspects, process 800 may include transmitting one or more SRSs according to the second set of SRS transmission parameters and based at least in part on receiving the indication (block 830). For example, the UE (e.g., using transmission component 1204, depicted in FIG. 12) may transmit one or more SRSs according to the second set of SRS transmission parameters and based at least in part on receiving the indication, as described above.

Process 800 may include additional aspects, such as any single aspect or any combination of aspects described below and/or in connection with one or more other processes described elsewhere herein.

In a first aspect, the first set of SRS transmission parameters indicates a first set of SRS resources, the second set of SRS transmission parameters indicates one or more SRS resources that are not included in the first set of SRS resources, and transmitting the one or more SRSs includes transmitting SRSs in the first set of SRS resources and the one or more SRS resources.

In a second aspect, alone or in combination with the first aspect, the one or more SRS resources are indicated in at least one of the configuration message or the indication to modify the SRS configuration.

In a third aspect, alone or in combination with one or more of the first and second aspects, the one or more SRS resources have a same periodicity as the first set of SRS resources.

In a fourth aspect, alone or in combination with one or more of the first through third aspects, the first set of SRS transmission parameters indicates a first periodicity for SRS resources, the second set of SRS transmission parameters indicates a second periodicity for the SRS resources, and transmitting the one or more SRSs includes transmitting the one or more SRSs according to the second periodicity.

In a fifth aspect, alone or in combination with one or more of the first through fourth aspects, process 800 includes receiving an indication to reactivate the SRS configuration indicated in the configuration message, and transmitting one or more SRSs according to the first set of SRS transmission parameters based at least in part on receiving the indication to reactivate the SRS configuration indicated in the configuration message.

In a sixth aspect, alone or in combination with one or more of the first through fifth aspects, the first set of SRS transmission parameters and the second set of SRS transmission parameters are associated with different numbers of SRS resources, different SRS resource periodicities, different numbers of symbols used for transmission of SRSs within a slot, different numbers of SRS ports to be used for SRS transmission, different mappings between SRS ports and SRS resources, different numbers of SRS repetitions, or a combination thereof.

In a seventh aspect, alone or in combination with one or more of the first through sixth aspects, the second set of SRS transmission parameters indicates a greater number of symbols used for SRSs within a slot as compared to the first set of SRS transmission parameters.

In an eighth aspect, alone or in combination with one or more of the first through seventh aspects, the second set of SRS transmission parameters activates SRS repetition using one or more repetitions.

In a ninth aspect, alone or in combination with one or more of the first through eighth aspects, the one or more repetitions occur within a same slot as a set of SRS resources indicated by the first set of transmission parameters.

In a tenth aspect, alone or in combination with one or more of the first through ninth aspects, the one or more repetitions occur in a different slot than a set of SRS resources indicated by the first set of transmission parameters.

In an eleventh aspect, alone or in combination with one or more of the first through tenth aspects, the different slot is adjacent to a slot in which the set of SRS resources occur.

In a twelfth aspect, alone or in combination with one or more of the first through eleventh aspects, the second set of SRS transmission parameters indicates a smaller number of SRS ports as compared to the first set of SRS transmission parameters.

In a thirteenth aspect, alone or in combination with one or more of the first through twelfth aspects, the second set of SRS transmission parameters indicates a different mapping between SRS ports and symbols as compared to the first set of SRS transmission parameters.

In a fourteenth aspect, alone or in combination with one or more of the first through thirteenth aspects, the indication is included in at least one of downlink control information or a MAC control element.

In a fifteenth aspect, alone or in combination with one or more of the first through fourteenth aspects, the indication is an indication to activate a coverage enhancement mode for the UE.

In a sixteenth aspect, alone or in combination with one or more of the first through fifteenth aspects, the indication is included in group common downlink control information associated with a group of UEs that includes the UE.

In a seventeenth aspect, alone or in combination with one or more of the first through sixteenth aspects, the indication causes different modifications to SRS configurations for at least two different UEs included in the group of UEs.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with SRS configuration modification.

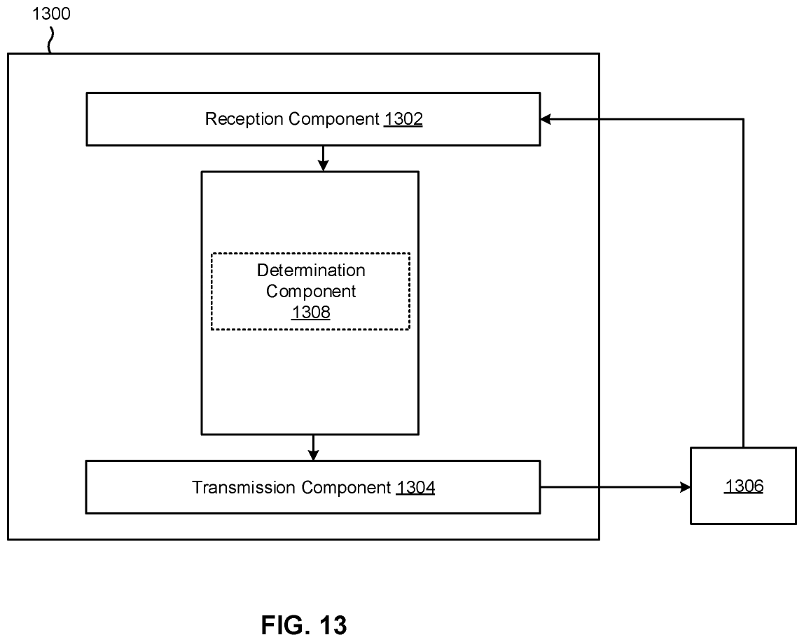

As shown in FIG. 9, in some aspects, process 900 may include transmitting a configuration message that includes an SRS configuration that indicates a first set of SRS transmission parameters for a UE (block 910). For example, the base station (e.g., using transmission component 1304, depicted in FIG. 13) may transmit a configuration message that includes an SRS configuration that indicates a first set of SRS transmission parameters for a UE, as described above.

As further shown in FIG. 9, in some aspects, process 900 may include transmitting an indication to modify the SRS configuration, wherein the indication is associated with a second set of SRS transmission parameters that are different from the first set of SRS transmission parameters (block 920). For example, the base station (e.g., using transmission component 1304, depicted in FIG. 13) may transmit an indication to modify the SRS configuration, wherein the indication is associated with a second set of SRS transmission parameters that are different from the first set of SRS transmission parameters, as described above.

As further shown in FIG. 9, in some aspects, process 900 may include receiving one or more SRSs according to the second set of SRS transmission parameters and based at least in part on transmitting the indication (block 930). For example, the base station (e.g., using reception component 1302, depicted in FIG. 13) may receive one or more SRSs according to the second set of SRS transmission parameters and based at least in part on transmitting the indication, as described above.

Process 900 may include additional aspects, such as any single aspect or any combination of aspects described below and/or in connection with one or more other processes described elsewhere herein.

In a first aspect, the first set of SRS transmission parameters indicates a first set of SRS resources, the second set of SRS transmission parameters indicates one or more SRS resources that are not included in the first set of SRS resources, and receiving the one or more SRSs includes receiving SRSs in the first set of SRS resources and the one or more SRS resources.

In a second aspect, alone or in combination with the first aspect, the one or more SRS resources are indicated in at least one of the configuration message or the indication to modify the SRS configuration.

In a third aspect, alone or in combination with one or more of the first and second aspects, the one or more SRS resources have a same periodicity as the first set of SRS resources.

In a fourth aspect, alone or in combination with one or more of the first through third aspects, the first set of SRS transmission parameters indicates a first periodicity for SRS resources, the second set of SRS transmission parameters indicates a second periodicity for the SRS resources, and receiving the one or more SRSs includes receiving the one or more SRSs according to the second periodicity.

In a fifth aspect, alone or in combination with one or more of the first through fourth aspects, process 900 includes transmitting an indication to reactivate the SRS configuration indicated in the configuration message, and receiving one or more SRSs according to the first set of SRS transmission parameters based at least in part on transmitting the indication to reactivate the SRS configuration indicated in the configuration message.

In a sixth aspect, alone or in combination with one or more of the first through fifth aspects, the first set of SRS transmission parameters and the second set of SRS transmission parameters are associated with different numbers of SRS resources, different SRS resource periodicities, different numbers of symbols used for transmission of SRSs within a slot, different numbers of SRS ports to be used for SRS transmission, different mappings between SRS ports and SRS resources, different numbers of SRS repetitions, or a combination thereof.

In a seventh aspect, alone or in combination with one or more of the first through sixth aspects, the second set of SRS transmission parameters indicates a greater number of symbols used for SRSs within a slot as compared to the first set of SRS transmission parameters.

In an eighth aspect, alone or in combination with one or more of the first through seventh aspects, the second set of SRS transmission parameters activates SRS repetition using one or more repetitions.

In a ninth aspect, alone or in combination with one or more of the first through eighth aspects, the one or more repetitions occur within a same slot as a set of SRS resources indicated by the first set of transmission parameters.

In a tenth aspect, alone or in combination with one or more of the first through ninth aspects, the one or more repetitions occur in a different slot than a set of SRS resources indicated by the first set of transmission parameters.

In an eleventh aspect, alone or in combination with one or more of the first through tenth aspects, the different slot is adjacent to a slot in which the set of SRS resources occur.

In a twelfth aspect, alone or in combination with one or more of the first through eleventh aspects, the second set of SRS transmission parameters indicates a smaller number of SRS ports as compared to the first set of SRS transmission parameters.

In a thirteenth aspect, alone or in combination with one or more of the first through twelfth aspects, the second set of SRS transmission parameters indicates a different mapping between SRS ports and symbols as compared to the first set of SRS transmission parameters.

In a fourteenth aspect, alone or in combination with one or more of the first through thirteenth aspects, the indication is included in at least one of downlink control information or a MAC control element.

In a fifteenth aspect, alone or in combination with one or more of the first through fourteenth aspects, the indication is an indication to activate a coverage enhancement mode for the UE.

In a sixteenth aspect, alone or in combination with one or more of the first through fifteenth aspects, the indication is included in group common downlink control information associated with a group of UEs that includes the UE.

In a seventeenth aspect, alone or in combination with one or more of the first through sixteenth aspects, the indication causes different modifications to the SRS configuration for at least two different UEs included in the group of UEs.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with dynamic switching of SRS configurations.

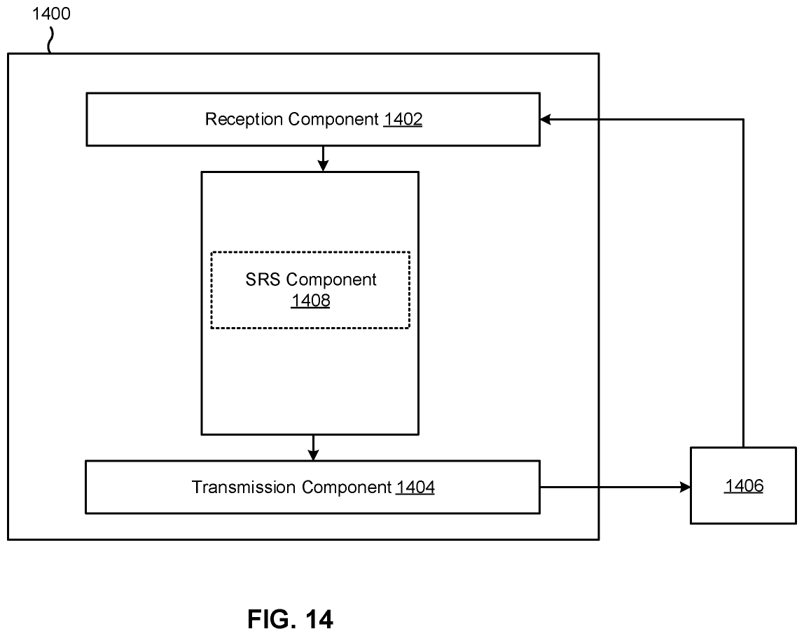

As shown in FIG. 10, in some aspects, process 1000 may include receiving a configuration message that indicates multiple SRS configurations, wherein different SRS configurations, of the multiple SRS configurations, are associated with different respective sets of SRS transmission parameters (block 1010). For example, the UE (e.g., using reception component 1402, depicted in FIG. 14) may receive a configuration message that indicates multiple SRS configurations, as described above. In some aspects, different SRS configurations, of the multiple SRS configurations, are associated with different respective sets of SRS transmission parameters, as described above.

As further shown in FIG. 10, in some aspects, process 1000 may include receiving an indication of an active SRS configuration of the multiple SRS configurations (block 1020). For example, the UE (e.g., using reception component 1402, depicted in FIG. 14) may receive an indication of an active SRS configuration of the multiple SRS configurations, as described above.

As further shown in FIG. 10, in some aspects, process 1000 may include transmitting one or more SRSs according to a set of SRS transmission parameters associated with the active SRS configuration (block 1030). For example, the UE (e.g., using transmission component 1404, depicted in FIG. 14) may transmit one or more SRSs according to a set of SRS transmission parameters associated with the active SRS configuration, as described above.

Process 1000 may include additional aspects, such as any single aspect or any combination of aspects described below and/or in connection with one or more other processes described elsewhere herein.

In a first aspect, the configuration message indicates a first active SRS configuration of the multiple SRS configurations, and receiving the indication of the active SRS configuration includes receiving an indication of a second active SRS configuration, of the multiple SRS configurations, that is different from the first active SRS configuration.

In a second aspect, alone or in combination with the first aspect, different SRS configurations, of the multiple SRS configurations, are associated with different numbers of SRS resources, different SRS resource periodicities, different mappings between SRS ports and SRS resources, different numbers of symbols used for transmission of SRSs within a slot, different numbers of SRS ports to be used for SRS transmission, different numbers of SRS repetitions, or a combination thereof.

In a third aspect, alone or in combination with one or more of the first and second aspects, a first SRS configuration, of the multiple SRS configurations, indicates a set of SRS resources, and a second SRS configuration, of the multiple SRS configurations, indicates one or more repetitions of the set of SRS resources.

In a fourth aspect, alone or in combination with one or more of the first through third aspects, the one or more repetitions occur within a same slot as the set of SRS resources.

In a fifth aspect, alone or in combination with one or more of the first through fourth aspects, the one or more repetitions occur in a different slot than the set of SRS resources.

In a sixth aspect, alone or in combination with one or more of the first through fifth aspects, the different slot is adjacent to a slot in which the set of SRS resources occur.

In a seventh aspect, alone or in combination with one or more of the first through sixth aspects, the indication is included in at least one of downlink control information or a MAC control element.

In an eighth aspect, alone or in combination with one or more of the first through seventh aspects, the indication is included in group common downlink control information associated with a group of UEs that includes the UE.

In a ninth aspect, alone or in combination with one or more of the first through eighth aspects, the indication includes an index value that maps to different SRS configurations for at least two different UEs included in the group of UEs.

In a tenth aspect, alone or in combination with one or more of the first through ninth aspects, the multiple SRS configurations are for periodic SRS transmissions.

In an eleventh aspect, alone or in combination with one or more of the first through tenth aspects, the multiple SRS configurations are for semi-persistent SRS transmissions.

In a twelfth aspect, alone or in combination with one or more of the first through eleventh aspects, the indication is received during a time period when semi-persistent SRS transmissions are activated, and the active SRS configuration is applied to the semi-persistent SRS transmissions.

In a thirteenth aspect, alone or in combination with one or more of the first through twelfth aspects, the indication is included in a message that activates the semi-persistent SRS transmissions.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with the present disclosure. Example process 1100 is an example where the base station (e.g., base station 110) performs operations associated with dynamic switching of SRS configurations.

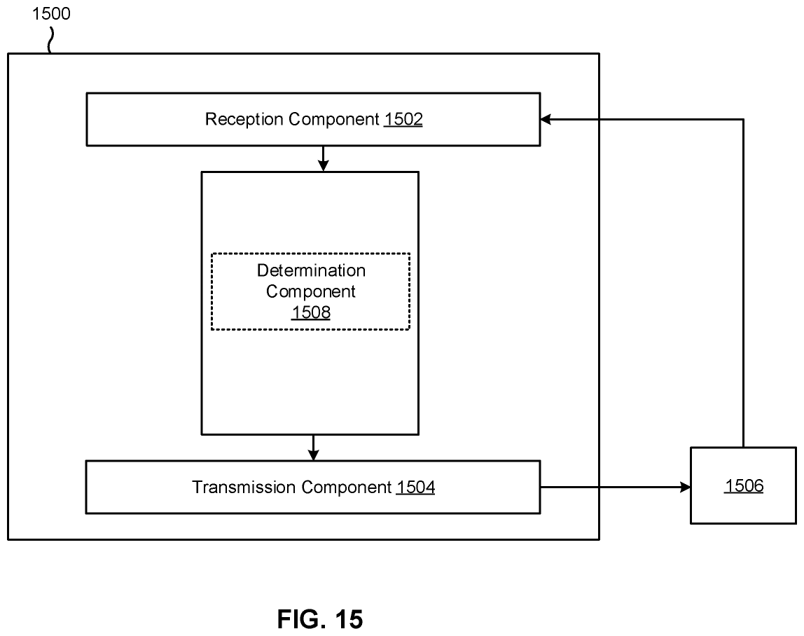

As shown in FIG. 11, in some aspects, process 1100 may include transmitting, to a UE, a configuration message that indicates multiple SRS configurations, wherein different SRS configurations, of the multiple SRS configurations, are associated with different respective sets of SRS transmission parameters (block 1110). For example, the base station (e.g., using transmission component 1504, depicted in FIG. 15) may transmit, to a UE, a configuration message that indicates SRS configurations, as described above. In some aspects, different SRS configurations, of the multiple SRS configurations, are associated with different respective sets of SRS transmission parameters, as described above.

As further shown in FIG. 11, in some aspects, process 1100 may include transmitting an indication of an active SRS configuration of the multiple SRS configurations (block 1120). For example, the base station (e.g., using transmission component 1504, depicted in FIG. 15) may transmit an indication of an active SRS configuration of the multiple SRS configurations, as described above.

As further shown in FIG. 11, in some aspects, process 1100 may include receiving one or more SRSs from the UE according to a set of SRS transmission parameters associated with the active SRS configuration (block 1130). For example, the base station (e.g., using reception component 1502, depicted in FIG. 15) may receive one or more SRSs from the UE according to a set of SRS transmission parameters associated with the active SRS configuration, as described above.

Process 1100 may include additional aspects, such as any single aspect or any combination of aspects described below and/or in connection with one or more other processes described elsewhere herein.

In a first aspect, the configuration message indicates a first active SRS configuration of the multiple SRS configurations, and transmitting the indication of the active SRS configuration includes transmitting an indication of a second active SRS configuration, of the multiple SRS configurations, that is different from the first active SRS configuration.

In a second aspect, alone or in combination with the first aspect, different SRS configurations, of the multiple SRS configurations, are associated with different numbers of SRS resources, different SRS resource periodicities, different mappings between SRS ports and SRS resources, different numbers of symbols used for transmission of SRSs within a slot, different numbers of SRS ports to be used for SRS transmission, different numbers of SRS repetitions, or a combination thereof.

In a third aspect, alone or in combination with one or more of the first and second aspects, a first SRS configuration, of the multiple SRS configurations, indicates a set of SRS resources, and a second SRS configuration, of the multiple SRS configurations, indicates one or more repetitions of the set of SRS resources.

In a fourth aspect, alone or in combination with one or more of the first through third aspects, the one or more repetitions occur within a same slot as the set of SRS resources.

In a fifth aspect, alone or in combination with one or more of the first through fourth aspects, the one or more repetitions occur in a different slot than the set of SRS resources.

In a sixth aspect, alone or in combination with one or more of the first through fifth aspects, the different slot is adjacent to a slot in which the set of SRS resources occur.

In a seventh aspect, alone or in combination with one or more of the first through sixth aspects, the indication is included in at least one of downlink control information or a MAC control element.

In an eighth aspect, alone or in combination with one or more of the first through seventh aspects, the indication is included in group common downlink control information associated with a group of UEs that includes the UE.

In a ninth aspect, alone or in combination with one or more of the first through eighth aspects, the indication includes an index value that maps to different SRS configurations for at least two different UEs included in the group of UEs.

In a tenth aspect, alone or in combination with one or more of the first through ninth aspects, the multiple SRS configurations are for periodic SRS transmissions.

In an eleventh aspect, alone or in combination with one or more of the first through tenth aspects, the multiple SRS configurations are for semi-persistent SRS transmissions.

In a twelfth aspect, alone or in combination with one or more of the first through eleventh aspects, the indication is transmitted during a time period when semi-persistent SRS transmissions are activated, and the active SRS configuration is applied to the semi-persistent SRS transmissions.

In a thirteenth aspect, alone or in combination with one or more of the first through twelfth aspects, the indication is included in a message that activates the semi-persistent SRS transmissions.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a block diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include an SRS component 1208.

In some aspects, the apparatus 1200 may be configured to perform one or more operations described herein in connection with FIGS. 5-7. Additionally or alternatively, the apparatus 1200 may be configured to perform one or more processes described herein, such as process 800 of FIG. 8. In some aspects, the apparatus 1200 and/or one or more components shown in FIG. 12 may include one or more components of the UE described above in connection with FIG. 2. Additionally, or alternatively, one or more components shown in FIG. 12 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the UE described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the UE described above in connection with FIG. 2. In some aspects, the transmission component 1204 may be collocated with the reception component 1202 in a transceiver.

The reception component 1202 may receive a configuration message that includes an SRS configuration that indicates a first set of SRS transmission parameters for the UE. The reception component 1202 may receive an indication to modify the SRS configuration, wherein the indication is associated with a second set of SRS transmission parameters that is different from the first set of SRS transmission parameters. The transmission component 1204 may transmit one or more SRSs according to the second set of SRS transmission parameters and based at least in part on receiving the indication.

The SRS component 1208 may generate one or more SRSs for transmission and/or otherwise perform processing associated with configuring and/or transmitting SRSs. The SRS component 1208 may include one or more components of the UE described above in connection with FIG. 2.

The reception component 1202 may receive an indication to reactivate the SRS configuration indicated in the configuration message. The transmission component 1204 may transmit one or more SRSs according to the first set of SRS transmission parameters based at least in part on receiving the indication to reactivate the SRS configuration indicated in the configuration message.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a base station, or a base station may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a determination component 1308.

In some aspects, the apparatus 1300 may be configured to perform one or more operations described herein in connection with FIGS. 5-7. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the base station described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the base station described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the base station described above in connection with FIG. 2. In some aspects, the transmission component 1304 may be collocated with the reception component 1302 in a transceiver.

The transmission component 1304 may transmit a configuration message that includes an SRS configuration that indicates a first set of SRS transmission parameters for a UE. The transmission component 1304 may transmit an indication to modify the SRS configuration, wherein the indication is associated with a second set of SRS transmission parameters that are different from the first set of SRS transmission parameters. The reception component 1302 may receive one or more SRSs according to the second set of SRS transmission parameters and based at least in part on transmitting the indication. In some aspects, the determination component 1308 may determine that the indication is to be transmitted (e.g., based at least in part on a channel estimation or channel conditions associated with the UE, a request from the UE, and/or the like).

The transmission component 1304 may transmit an indication to reactivate the SRS configuration indicated in the configuration message. The reception component 1302 may receive one or more SRSs according to the first set of SRS transmission parameters based at least in part on transmitting the indication to reactivate the SRS configuration indicated in the configuration message.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a block diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include an SRS component 1408.

In some aspects, the apparatus 1400 may be configured to perform one or more operations described herein in connection with FIGS. 5-7. Additionally or alternatively, the apparatus 1400 may be configured to perform one or more processes described herein, such as process 1000 of FIG. 10. In some aspects, the apparatus 1400 and/or one or more components shown in FIG. 14 may include one or more components of the UE described above in connection with FIG. 2. Additionally, or alternatively, one or more components shown in FIG. 14 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the UE described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the UE described above in connection with FIG. 2. In some aspects, the transmission component 1404 may be collocated with the reception component 1402 in a transceiver.

The reception component 1402 may receive a configuration message that indicates multiple SRS configurations, wherein different SRS configurations, of the multiple SRS configurations, are associated with different respective sets of SRS transmission parameters. The reception component 1402 may receive an indication of an active SRS configuration of the multiple SRS configurations. The transmission component 1404 may transmit one or more SRSs according to a set of SRS transmission parameters associated with the active SRS configuration.

The SRS component 1408 may generate one or more SRSs for transmission and/or otherwise perform processing associated with configuring and/or transmitting SRSs. The SRS component 1408 may include one or more components of the UE described above in connection with FIG. 2.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

FIG. 15 is a block diagram of an example apparatus 1500 for wireless communication. The apparatus 1500 may be a base station, or a base station may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include a determination component 1508.

In some aspects, the apparatus 1500 may be configured to perform one or more operations described herein in connection with FIGS. 5-7. Additionally or alternatively, the apparatus 1500 may be configured to perform one or more processes described herein, such as process 1100 of FIG. 11. In some aspects, the apparatus 1500 and/or one or more components shown in FIG. 15 may include one or more components of the base station described above in connection with FIG. 2. Additionally, or alternatively, one or more components shown in FIG. 15 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1506. In some aspects, the reception component 1502 may include one or more antennas, a demodulator, a MIMO detector, a receive processor, a controller/processor, a memory, or a combination thereof, of the base station described above in connection with FIG. 2.

The transmission component 1504 may transmit communications, such as reference signals, control information, data communications, or a combination thereof, to the apparatus 1506. In some aspects, one or more other components of the apparatus 1506 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modulator, a transmit MIMO processor, a transmit processor, a controller/processor, a memory, or a combination thereof, of the base station described above in connection with FIG. 2. In some aspects, the transmission component 1504 may be collocated with the reception component 1502 in a transceiver.

The transmission component 1504 may transmit, to a UE, a configuration message that indicates multiple SRS configurations, wherein different SRS configurations, of the multiple SRS configurations, are associated with different respective sets of SRS transmission parameters. The transmission component 1504 may transmit an indication of an active SRS configuration of the multiple SRS configurations. The reception component 1502 may receive one or more SRSs from the UE according to a set of SRS transmission parameters associated with the active SRS configuration. In some aspects, the determination component 1508 may determine that the indication is to be transmitted (e.g., based at least in part on a channel estimation or channel conditions associated with the UE, a request from the UE, and/or the like).

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving a configuration message that includes a sounding reference signal (SRS) configuration that indicates a first set of SRS transmission parameters for the UE; receiving an indication to modify the SRS configuration, wherein the indication is associated with a second set of SRS transmission parameters that is different from the first set of SRS transmission parameters; and transmitting one or more SRSs according to the second set of SRS transmission parameters and based at least in part on receiving the indication.

Aspect 2: The method of Aspect 1, wherein the first set of SRS transmission parameters indicates a first set of SRS resources, wherein the second set of SRS transmission parameters indicates one or more SRS resources that are not included in the first set of SRS resources, and wherein transmitting the one or more SRSs comprises transmitting SRSs in the first set of SRS resources and the one or more SRS resources.

Aspect 3: The method of Aspect 2, wherein the one or more SRS resources are indicated in at least one of the configuration message or the indication to modify the SRS configuration.

Aspect 4: The method of any of Aspects 2-3, wherein the one or more SRS resources have a same periodicity as the first set of SRS resources.

Aspect 5: The method of any of Aspects 1-4, wherein the first set of SRS transmission parameters indicates a first periodicity for SRS resources, wherein the second set of SRS transmission parameters indicates a second periodicity for the SRS resources, and wherein transmitting the one or more SRSs comprises transmitting the one or more SRSs according to the second periodicity.

Aspect 6: The method of any of Aspects 1-5, further comprising: receiving an indication to reactivate the SRS configuration indicated in the configuration message; and transmitting one or more SRSs according to the first set of SRS transmission parameters based at least in part on receiving the indication to reactivate the SRS configuration indicated in the configuration message.

Aspect 7: The method of any of Aspects 1-6, wherein the first set of SRS transmission parameters and the second set of SRS transmission parameters are associated with different numbers of SRS resources, different SRS resource periodicities, different numbers of symbols used for transmission of SRSs within a slot, different numbers of SRS ports to be used for SRS transmission, different mappings between SRS ports and SRS resources, different numbers of SRS repetitions, or a combination thereof.

Aspect 8: The method of any of Aspects 1-7, wherein the second set of SRS transmission parameters indicates a greater number of symbols used for SRSs within a slot as compared to the first set of SRS transmission parameters.

Aspect 9: The method of any of Aspects 1-8, wherein the second set of SRS transmission parameters activates SRS repetition using one or more repetitions.

Aspect 10: The method of Aspect 9, wherein the one or more repetitions occur within a same slot as a set of SRS resources indicated by the first set of transmission parameters.

Aspect 11: The method of Aspect 9, wherein the one or more repetitions occur in a different slot than a set of SRS resources indicated by the first set of transmission parameters.

Aspect 12: The method of Aspect 11, wherein the different slot is adjacent to a slot in which the set of SRS resources occur.

Aspect 13: The method of any of Aspects 1-12, wherein the second set of SRS transmission parameters indicates a smaller number of SRS ports as compared to the first set of SRS transmission parameters.

Aspect 14: The method of any of Aspects 1-13, wherein the second set of SRS transmission parameters indicates a different mapping between SRS ports and symbols as compared to the first set of SRS transmission parameters.

Aspect 15: The method of any of Aspects 1-14, wherein the indication is included in at least one of downlink control information or a medium access control (MAC) control element.

Aspect 16: The method of any of Aspects 1-15, wherein the indication is an indication to activate a coverage enhancement mode for the UE.

Aspect 17: The method of any of Aspects 1-16, wherein the indication is included in group common downlink control information associated with a group of UEs that includes the UE.

Aspect 18: The method of Aspect 17, wherein the indication causes different modifications to SRS configurations for at least two different UEs included in the group of UEs.

Aspect 19: A method of wireless communication performed by a base station, comprising: transmitting a configuration message that includes a sounding reference signal (SRS) configuration that indicates a first set of SRS transmission parameters for a user equipment (UE); transmitting an indication to modify the SRS configuration, wherein the indication is associated with a second set of SRS transmission parameters that are different from the first set of SRS transmission parameters; and receiving one or more SRSs according to the second set of SRS transmission parameters and based at least in part on transmitting the indication.

Aspect 20: The method of Aspect 19, wherein the first set of SRS transmission parameters indicates a first set of SRS resources, wherein the second set of SRS transmission parameters indicates one or more SRS resources that are not included in the first set of SRS resources, and wherein receiving the one or more SRSs comprises receiving SRSs in the first set of SRS resources and the one or more SRS resources.

Aspect 21: The method of Aspect 20, wherein the one or more SRS resources are indicated in at least one of the configuration message or the indication to modify the SRS configuration.

Aspect 22: The method of any of Aspects 20-21, wherein the one or more SRS resources have a same periodicity as the first set of SRS resources.

Aspect 23: The method of any of Aspects 19-22, wherein the first set of SRS transmission parameters indicates a first periodicity for SRS resources, wherein the second set of SRS transmission parameters indicates a second periodicity for the SRS resources, and wherein receiving the one or more SRSs comprises receiving the one or more SRSs according to the second periodicity.

Aspect 24: The method of any of Aspects 19-23, further comprising: transmitting an indication to reactivate the SRS configuration indicated in the configuration message; and receiving one or more SRSs according to the first set of SRS transmission parameters based at least in part on transmitting the indication to reactivate the SRS configuration indicated in the configuration message.

Aspect 25: The method of any of Aspects 19-24, wherein the first set of SRS transmission parameters and the second set of SRS transmission parameters are associated with different numbers of SRS resources, different SRS resource periodicities, different numbers of symbols used for transmission of SRSs within a slot, different numbers of SRS ports to be used for SRS transmission, different mappings between SRS ports and SRS resources, different numbers of SRS repetitions, or a combination thereof.

Aspect 26: The method of any of Aspects 19-25, wherein the second set of SRS transmission parameters indicates a greater number of symbols used for SRSs within a slot as compared to the first set of SRS transmission parameters.

Aspect 27: The method of any of Aspects 19-26, wherein the second set of SRS transmission parameters activates SRS repetition using one or more repetitions.

Aspect 28: The method of Aspect 27, wherein the one or more repetitions occur within a same slot as a set of SRS resources indicated by the first set of transmission parameters.

Aspect 29: The method of Aspect 27, wherein the one or more repetitions occur in a different slot than a set of SRS resources indicated by the first set of transmission parameters.

Aspect 30: The method of Aspect 29, wherein the different slot is adjacent to a slot in which the set of SRS resources occur.

Aspect 31: The method of any of Aspects 19-30, wherein the second set of SRS transmission parameters indicates a smaller number of SRS ports as compared to the first set of SRS transmission parameters.

Aspect 32: The method of any of Aspects 19-31, wherein the second set of SRS transmission parameters indicates a different mapping between SRS ports and symbols as compared to the first set of SRS transmission parameters.

Aspect 33: The method of any of Aspects 19-32, wherein the indication is included in at least one of downlink control information or a medium access control (MAC) control element.

Aspect 34: The method of any of Aspects 19-33, wherein the indication is an indication to activate a coverage enhancement mode for the UE.

Aspect 35: The method of any of Aspects 19-34, wherein the indication is included in group common downlink control information associated with a group of UEs that includes the UE.

Aspect 36: The method of Aspect 35, wherein the indication causes different modifications to the SRS configuration for at least two different UEs included in the group of UEs.

Aspect 37: A method of wireless communication performed by a user equipment (UE), comprising: receiving a configuration message that indicates multiple sounding reference signal (SRS) configurations, wherein different SRS configurations, of the multiple SRS configurations, are associated with different respective sets of SRS transmission parameters; receiving an indication of an active SRS configuration of the multiple SRS configurations; and transmitting one or more SRSs according to a set of SRS transmission parameters associated with the active SRS configuration.

Aspect 38: The method of Aspect 37, wherein the configuration message indicates a first active SRS configuration of the multiple SRS configurations; and wherein receiving the indication of the active SRS configuration comprises receiving an indication of a second active SRS configuration, of the multiple SRS configurations, that is different from the first active SRS configuration.

Aspect 39: The method of any of Aspects 37-38, wherein different SRS configurations, of the multiple SRS configurations, are associated with different numbers of SRS resources, different SRS resource periodicities, different mappings between SRS ports and SRS resources, different numbers of symbols used for transmission of SRSs within a slot, different numbers of SRS ports to be used for SRS transmission, different numbers of SRS repetitions, or a combination thereof.

Aspect 40: The method of any of Aspects 37-39, wherein a first SRS configuration, of the multiple SRS configurations, indicates a set of SRS resources, and wherein a second SRS configuration, of the multiple SRS configurations, indicates one or more repetitions of the set of SRS resources.

Aspect 41: The method of Aspect 40, wherein the one or more repetitions occur within a same slot as the set of SRS resources.

Aspect 42: The method of Aspect 40, wherein the one or more repetitions occur in a different slot than the set of SRS resources.

Aspect 43: The method of Aspect 42, wherein the different slot is adjacent to a slot in which the set of SRS resources occur.

Aspect 44: The method of any of Aspects 37-43, wherein the indication is included in at least one of downlink control information or a medium access control (MAC) control element.

Aspect 45: The method of any of Aspects 37-43, wherein the indication is included in group common downlink control information associated with a group of UEs that includes the UE.

Aspect 46: The method of Aspect 45, wherein the indication includes an index value that maps to different SRS configurations for at least two different UEs included in the group of UEs.

Aspect 47: The method of any of Aspects 37-46, wherein the multiple SRS configurations are for periodic SRS transmissions.

Aspect 48: The method of any of Aspects 37-47, wherein the multiple SRS configurations are for semi-persistent SRS transmissions.

Aspect 49: The method of Aspect 48, wherein the indication is received during a time period when semi-persistent SRS transmissions are activated, and wherein the active SRS configuration is applied to the semi-persistent SRS transmissions.

Aspect 50: The method of any of Aspects 48-49, wherein the indication is included in a message that activates the semi-persistent SRS transmissions.

Aspect 51: A method of wireless communication performed by a base station, comprising: transmitting, to a user equipment (UE), a configuration message that indicates multiple sounding reference signal (SRS) configurations, wherein different SRS configurations, of the multiple SRS configurations, are associated with different respective sets of SRS transmission parameters; transmitting an indication of an active SRS configuration of the multiple SRS configurations; and receiving one or more SRSs from the UE according to a set of SRS transmission parameters associated with the active SRS configuration.

Aspect 52: The method of Aspect 51, wherein the configuration message indicates a first active SRS configuration of the multiple SRS configurations; and wherein transmitting the indication of the active SRS configuration comprises transmitting an indication of a second active SRS configuration, of the multiple SRS configurations, that is different from the first active SRS configuration.

Aspect 53: The method of any of Aspects 51-52, wherein different SRS configurations, of the multiple SRS configurations, are associated with different numbers of SRS resources, different SRS resource periodicities, different mappings between SRS ports and SRS resources, different numbers of symbols used for transmission of SRSs within a slot, different numbers of SRS ports to be used for SRS transmission, different numbers of SRS repetitions, or a combination thereof.

Aspect 54: The method of any of Aspects 51-53, wherein a first SRS configuration, of the multiple SRS configurations, indicates a set of SRS resources, and

wherein a second SRS configuration, of the multiple SRS configurations, indicates one or more repetitions of the set of SRS resources.

Aspect 55: The method of Aspect 54, wherein the one or more repetitions occur within a same slot as the set of SRS resources.

Aspect 56: The method of Aspect 54, wherein the one or more repetitions occur in a different slot than the set of SRS resources.

Aspect 57: The method of Aspect 56, wherein the different slot is adjacent to a slot in which the set of SRS resources occur.

Aspect 58: The method of any of Aspects 51-57, wherein the indication is included in at least one of downlink control information or a medium access control (MAC) control element.

Aspect 59: The method of any of Aspects 51-57, wherein the indication is included in group common downlink control information associated with a group of UEs that includes the UE.

Aspect 60: The method of Aspect 59, wherein the indication includes an index value that maps to different SRS configurations for at least two different UEs included in the group of UEs.

Aspect 61: The method of any of Aspects 51-60, wherein the multiple SRS configurations are for periodic SRS transmissions.

Aspect 62: The method of any of Aspects 51-61, wherein the multiple SRS configurations are for semi-persistent SRS transmissions.

Aspect 63: The method of Aspect 62, wherein the indication is transmitted during a time period when semi-persistent SRS transmissions are activated, and wherein the active SRS configuration is applied to the semi-persistent SRS transmissions.

Aspect 64: The method of any of Aspects 62-63, wherein the indication is included in a message that activates the semi-persistent SRS transmissions.

Aspect 65: An apparatus for wireless communication at a device, comprising a processor; memory coupled with the processor; and instructions stored in the memory and executable by the processor to cause the apparatus to perform the method of one or more of Aspects 1-18.

Aspect 66: A device for wireless communication, comprising a memory and one or more processors coupled to the memory, the one or more processors configured to perform the method of one or more of Aspects 1-18.

Aspect 67: An apparatus for wireless communication, comprising at least one means for performing the method of one or more of Aspects 1-18.

Aspect 68: A non-transitory computer-readable medium storing code for wireless communication, the code comprising instructions executable by a processor to perform the method of one or more of Aspects 1-18.

Aspect 69: A non-transitory computer-readable medium storing a set of instructions for wireless communication, the set of instructions comprising one or more instructions that, when executed by one or more processors of a device, cause the device to perform the method of one or more of Aspects 1-18.

Aspect 70: An apparatus for wireless communication at a device, comprising a processor; memory coupled with the processor; and instructions stored in the memory and executable by the processor to cause the apparatus to perform the method of one or more of Aspects 19-36.

Aspect 71: A device for wireless communication, comprising a memory and one or more processors coupled to the memory, the one or more processors configured to perform the method of one or more of Aspects 19-36.

Aspect 72: An apparatus for wireless communication, comprising at least one means for performing the method of one or more of Aspects 19-36.

Aspect 73: A non-transitory computer-readable medium storing code for wireless communication, the code comprising instructions executable by a processor to perform the method of one or more of Aspects 19-36.

Aspect 74: A non-transitory computer-readable medium storing a set of instructions for wireless communication, the set of instructions comprising one or more instructions that, when executed by one or more processors of a device, cause the device to perform the method of one or more of Aspects 19-36.

Aspect 75: An apparatus for wireless communication at a device, comprising a processor; memory coupled with the processor; and instructions stored in the memory and executable by the processor to cause the apparatus to perform the method of one or more of Aspects 37-50.

Aspect 76: A device for wireless communication, comprising a memory and one or more processors coupled to the memory, the one or more processors configured to perform the method of one or more of Aspects 37-50.

Aspect 77: An apparatus for wireless communication, comprising at least one means for performing the method of one or more of Aspects 37-50.

Aspect 78: A non-transitory computer-readable medium storing code for wireless communication, the code comprising instructions executable by a processor to perform the method of one or more of Aspects 37-50.

Aspect 79: A non-transitory computer-readable medium storing a set of instructions for wireless communication, the set of instructions comprising one or more instructions that, when executed by one or more processors of a device, cause the device to perform the method of one or more of Aspects 37-50.

Aspect 80: An apparatus for wireless communication at a device, comprising a processor; memory coupled with the processor; and instructions stored in the memory and executable by the processor to cause the apparatus to perform the method of one or more of Aspects 51-64.

Aspect 81: A device for wireless communication, comprising a memory and one or more processors coupled to the memory, the one or more processors configured to perform the method of one or more of Aspects 51-64.

Aspect 82: An apparatus for wireless communication, comprising at least one means for performing the method of one or more of Aspects 51-64.

Aspect 83: A non-transitory computer-readable medium storing code for wireless communication, the code comprising instructions executable by a processor to perform the method of one or more of Aspects 51-64.

Aspect 84: A non-transitory computer-readable medium storing a set of instructions for wireless communication, the set of instructions comprising one or more instructions that, when executed by one or more processors of a device, cause the device to perform the method of one or more of Aspects 51-64.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a configuration message that includes a sounding reference signal (SRS) configuration that indicates a first set of SRS transmission parameters for the UE;
receive an indication to modify the SRS configuration, wherein the indication is associated with a second set of SRS transmission parameters that is different from the first set of SRS transmission parameters; and
transmit one or more SRSs according to the second set of SRS transmission parameters and based at least in part on receiving the indication.

2. The UE of claim 1, wherein the first set of SRS transmission parameters indicates a first set of SRS resources, wherein the second set of SRS transmission parameters indicates one or more SRS resources that are not included in the first set of SRS resources, and wherein transmitting the one or more SRSs comprises transmitting SRSs in the first set of SRS resources and the one or more SRS resources.

3. The UE of claim 2, wherein the one or more SRS resources are indicated in at least one of the configuration message or the indication to modify the SRS configuration.

4. The UE of claim 2, wherein the one or more SRS resources have a same periodicity as the first set of SRS resources.

5. The UE of claim 1, wherein the first set of SRS transmission parameters indicates a first periodicity for SRS resources, wherein the second set of SRS transmission parameters indicates a second periodicity for the SRS resources, and wherein transmitting the one or more SRSs comprises transmitting the one or more SRSs according to the second periodicity.

6. The UE of claim 1, wherein the one or more processors are further configured to:
receive an indication to reactivate the SRS configuration indicated in the configuration message; and
transmit one or more SRSs according to the first set of SRS transmission parameters based at least in part on receiving the indication to reactivate the SRS configuration indicated in the configuration message.

7. The UE of claim 1, wherein the first set of SRS transmission parameters and the second set of SRS transmission parameters are associated with different numbers of SRS resources, different SRS resource periodicities, different numbers of symbols used for transmission of SRSs within a slot, different numbers of SRS ports to be used for SRS transmission, different mappings between SRS ports and SRS resources, different numbers of SRS repetitions, or a combination thereof.

8. The UE of claim 1, wherein the second set of SRS transmission parameters indicates a greater number of symbols used for SRSs within a slot as compared to the first set of SRS transmission parameters.

9. The UE of claim 1, wherein the second set of SRS transmission parameters activates SRS repetition using one or more repetitions.

10. The UE of claim 1, wherein the second set of SRS transmission parameters indicates a smaller number of SRS ports as compared to the first set of SRS transmission parameters.

11. The UE of claim 1, wherein the second set of SRS transmission parameters indicates a different mapping between SRS ports and symbols as compared to the first set of SRS transmission parameters.

12. A user equipment (UE) for wireless communication, comprising:
a memory; and
one or more processors, coupled to the memory, configured to:
receive a configuration message that indicates multiple sounding reference signal (SRS) configurations, wherein different SRS configurations, of the multiple SRS configurations, are associated with different respective sets of SRS transmission parameters;
receive an indication of an active SRS configuration of the multiple SRS configurations; and
transmit one or more SRSs according to a set of SRS transmission parameters associated with the active SRS configuration.

13. The UE of claim 12, wherein the configuration message indicates a first active SRS configuration of the multiple SRS configurations; and
wherein the one or more processors, to receive the indication of the active SRS configuration, are configured to receive an indication of a second active SRS configuration, of the multiple SRS configurations, that is different from the first active SRS configuration.

14. The UE of claim 12, wherein different SRS configurations, of the multiple SRS configurations, are associated with different numbers of SRS resources, different SRS resource periodicities, different mappings between SRS ports and SRS resources, different numbers of symbols used for transmission of SRSs within a slot, different numbers of SRS ports to be used for SRS transmission, different numbers of SRS repetitions, or a combination thereof.

15. The UE of claim 12, wherein a first SRS configuration, of the multiple SRS configurations, indicates a set of SRS resources, and
wherein a second SRS configuration, of the multiple SRS configurations, indicates one or more repetitions of the set of SRS resources.

16. A method of wireless communication performed by a user equipment (UE), comprising:
receiving a configuration message that includes a sounding reference signal (SRS) configuration that indicates a first set of SRS transmission parameters for the UE;
receiving an indication to modify the SRS configuration, wherein the indication is associated with a second set of SRS transmission parameters that is different from the first set of SRS transmission parameters; and
transmitting one or more SRSs according to the second set of SRS transmission parameters and based at least in part on receiving the indication.

17. The method of claim 16, wherein the first set of SRS transmission parameters indicates a first set of SRS resources, wherein the second set of SRS transmission parameters indicates one or more SRS resources that are not included in the first set of SRS resources, and wherein transmitting the one or more SRSs comprises transmitting SRSs in the first set of SRS resources and the one or more SRS resources.

18. The method of claim 17, wherein the one or more SRS resources are indicated in at least one of the configuration message or the indication to modify the SRS configuration.

19. The method of claim 17, wherein the one or more SRS resources have a same periodicity as the first set of SRS resources.

20. The method of claim 16, wherein the first set of SRS transmission parameters indicates a first periodicity for SRS resources, wherein the second set of SRS transmission parameters indicates a second periodicity for the SRS resources, and wherein transmitting the one or more SRSs comprises transmitting the one or more SRSs according to the second periodicity.

21. The method of claim 16, further comprising:
receiving an indication to reactivate the SRS configuration indicated in the configuration message; and
transmitting one or more SRSs according to the first set of SRS transmission parameters based at least in part on receiving the indication to reactivate the SRS configuration indicated in the configuration message.

22. The method of claim 16, wherein the first set of SRS transmission parameters and the second set of SRS transmission parameters are associated with different numbers of SRS resources, different SRS resource periodicities, different numbers of symbols used for transmission of SRSs within a slot, different numbers of SRS ports to be used for SRS transmission, different mappings between SRS ports and SRS resources, different numbers of SRS repetitions, or a combination thereof.

23. The method of claim 16, wherein the second set of SRS transmission parameters indicates a greater number of symbols used for SRSs within a slot as compared to the first set of SRS transmission parameters.

24. The method of claim 16, wherein the second set of SRS transmission parameters activates SRS repetition using one or more repetitions.

25. The method of claim 16, wherein the second set of SRS transmission parameters indicates a smaller number of SRS ports as compared to the first set of SRS transmission parameters.

26. The method of claim 16, wherein the second set of SRS transmission parameters indicates a different mapping between SRS ports and symbols as compared to the first set of SRS transmission parameters.

27. A method of wireless communication performed by a user equipment (UE), comprising:
receiving a configuration message that indicates multiple sounding reference signal (SRS) configurations, wherein different SRS configurations, of the multiple SRS configurations, are associated with different respective sets of SRS transmission parameters;
receiving an indication of an active SRS configuration of the multiple SRS configurations; and
transmitting one or more SRSs according to a set of SRS transmission parameters associated with the active SRS configuration.

28. The method of claim 27, wherein the configuration message indicates a first active SRS configuration of the multiple SRS configurations; and
wherein receiving the indication of the active SRS configuration comprises receiving an indication of a second active SRS configuration, of the multiple SRS configurations, that is different from the first active SRS configuration.

29. The method of claim 27, wherein different SRS configurations, of the multiple SRS configurations, are associated with different numbers of SRS resources, different SRS resource periodicities, different mappings between SRS ports and SRS resources, different numbers of symbols used for transmission of SRSs within a slot, different numbers of SRS ports to be used for SRS transmission, different numbers of SRS repetitions, or a combination thereof.

30. The method of claim 27, wherein a first SRS configuration, of the multiple SRS configurations, indicates a set of SRS resources, and
wherein a second SRS configuration, of the multiple SRS configurations, indicates one or more repetitions of the set of SRS resources.
